(19) United States
(12) Patent Application Publication
(10) Pub. No.: US 2026/0368781 A1
(43) Pub. Date: Nov. 19, 2026

(54) MACHINE LEARNING MODEL FOR PREDICTING VALUES IN A RANGE OF VALUES

(71) Applicant: Microsoft Technology Licensing, LLC, Redmond, WA (US)

(72) Inventors: Ruby Tu, Redmond, WA (US); Shengjun Pan, Fremont, CA (US); Min Liu, Redmond, WA (US); Xi Xiong, Sunnyvale, CA (US); Yi Zhang, Los Altos, CA (US); Yuan Gao, Santa Clara, CA (US); Haipeng Gao, Cupertino, CA (US)

(73) Assignee: Microsoft Technology Licensing, LLC, Redmond, WA (US)

(21) Appl. No.: 19/211,747

(22) Filed: May 19, 2025

(51) Int. Cl. G06Q 30/0273; G06N 20/00

(52) U.S. Cl. CPC G06Q 30/0275; G06N 20/00

(57) ABSTRACT

Machine learning techniques predicting bid values are described. A method comprises receiving an input vector comprising bid request data associated with a bid request, generating a bid upper boundary value for a prediction interval based on the input vector using a first ML model, the first ML model trained on a first set of training datapoints, wherein a first training datapoint comprises an accepted bid from a first set of auctions, generating a bid lower boundary value for the prediction interval based on the input vector using a second ML model, the second ML model trained on a second set of training datapoints, wherein a second training datapoint comprises a rejected bid from a second set of auctions, selecting a bid value from a range of candidate bid values of the prediction interval, and sending bid response data comprising the selected bid value in response to the bid request.

### BACKGROUND

Real-time bidding (RTB) is an automated auction system that enables the buying and selling of impressions in milliseconds. A digital content exchange receives various bids and it selects a winner for the impression based on the bids. The winner sends the content item to the publishing platform for publishing in the content slot. This process ensures the creative appears seamlessly as the page loads, tailored to the user profile (e.g., location or interests), while the process remains invisible to the user. Therefore, improvements to RTB are needed to increase speed, precision, and data-driven decisions to allow digital content producers to better target individual impressions of a publishing platform.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a real-time bidding (RTB) system in accordance with one embodiment.

FIG. 2 illustrates a logic diagram in accordance with one embodiment.

FIG. 3 illustrates a machine learning (ML) architecture in accordance with one embodiment.

FIG. 4 illustrates a transformer model in accordance with one embodiment.

FIG. 5 illustrates a training system in accordance with one embodiment.

FIG. 6 illustrates a system in accordance with one embodiment.

FIG. 7 illustrates a logic flow in accordance with one embodiment.

FIG. 8 illustrates a logic flow in accordance with one embodiment.

FIG. 9 illustrates a connection network system in accordance with one embodiment.

FIG. 10 illustrates a computing architecture in accordance with one embodiment.

### DETAILED DESCRIPTION

### Overview

Real-time bidding (RTB) is an automated auction system that enables the buying and selling of impressions in milliseconds. When a user loads a webpage or application, a publishing platform sends bid request data through a supply-side platform (SSP) to a digital content exchange, detailing a user profile and a content slot for an impression. The digital content exchange then initiates an auction for the impression by distributing the bid request data to various demand-side platforms (DSPs) representing digital content producers. Each DSP uses algorithms to analyze the bid request data against campaign goals for a digital content producer, such as a target audience, budget, and a content item. Each DSP then submits a bid to the digital content exchange in real-time. The digital content exchange receives the various bids and it selects a winner for the impression based on the bids. The winner sends the content item to the publishing platform for publishing in the content slot. This process ensures the creative appears seamlessly as the page loads, tailored to the user profile (e.g., location or interests), while the process remains invisible to the user. Therefore, improvements to RTB are needed to increase speed, precision, and data-driven decisions to allow digital content producers to better target individual impressions of a publishing platform.

In an RTB auction, an impression refers to a single instance of a content item (e.g., a creative) displayed to a user on a digital platform, such as a website, application, or video player. It is a core unit of trade in the RTB ecosystem, on which digital content producers bid and digital content publishers sell. Each time a user loads a page or engages with digital content where a content slot is available, that opportunity to show a content item counts as one impression.

The value of an impression in RTB hinges on the context and the user behind it. When an auction starts, the bid request data includes details associated with a user (e.g., demographics, location, device type, and browsing history), and the specifics of the content slot (e.g., size data, page data, and position data). This data helps digital content producers to decide how much that impression is worth to them. For example, whether a 30-year-old gamer in New York seeing a creative is more valuable than a 50-year-old reader in Texas.

Once an auction concludes, the winning creative is served, and the impression is “delivered,” meaning the creative appears on an electronic display of a client device. It is a one-time event tied to that specific moment. If the user refreshes the page, a new impression is generated, sparking another auction. In short, an impression is both the opportunity and the outcome of a RTB auction, driving the fast-paced, targeted world of digital publishing.

To keep pace with the real-time speed of the bidding process, a DSP service uses an ML model to predict a winning bid for a given RTB auction. The ML model analyzes historical data, user features, and contextual signals to estimate an optimal bid amount that maximizes objectives of a given campaign. The objectives are typically a balance between winning the impression and achieving a desired outcome like clicks, conversions, or return on investment (ROI).

The ML model is trained using historical data from past auctions, including bid request data (e.g., user demographics, location, device type, browsing behavior), content slot details (e.g., size, placement), and outcomes (e.g., clicks, conversions, contribution). It also incorporates real-time data from a current bid request. Features are engineered to capture patterns, such as time of day, site category, or user intent, thereby turning raw data into variables the ML model can process. For example, a feature might flag a user as a “high-value shopper” based on their history. A supervised learning model, such as regression (e.g., linear or logistic regression), decision trees, or neural networks, is trained on this data to predict either the expected value of the impression (e.g., likelihood of a click times the value of that click) or the bid landscape (e.g., what others are likely to bid). For instance, a model might learn that impressions on technical websites at 8 PM for 25-34 year-old males historically yield a $0.05 click-through rate with a $2 conversion value, suggesting a bid around $0.10. Advanced models, like reinforcement learning, might dynamically adjust bids by simulating auction outcomes over time, optimizing for long-term ROI rather than just one auction. Once the model predicts an impression value, it adjusts the bid based on constraints like budget, campaign goals, and auction dynamics (e.g., second-price rules, where it bids slightly above the predicted second-highest bid). The final bid is submitted to the digital content exchange within milliseconds. For example, if the model estimates an impression value of $4 and predicts the next-highest bid at $3, it might bid $3.01. Over time, the model refines itself with feedback such as win rates, costs, and conversions to improve its accuracy for future auctions. In practice, this process leverages vast computational power and real-time data pipelines of a DSP to provide a competitive advantage to a digital content publisher. For example, a model might decide a gamer's impression on a mobile game content slot is worth $5 based on their in-app purchase history, outbidding a $2 generic bid from a less-informed competitor. The model blends statistics, pattern recognition, and strategy, all compressed into a split-second decision.

Existing ML models face significant technical challenges when attempting to predict a winning bid for an RTB auction. The bidding process typically follows a second-price auction model, where the highest bidder wins but pays just above the second-highest bid. For instance, if bids are $4 and $3, the winner pays $3.01. If bids from competitors were fixed and known, the probability of winning behaves as a step function. When the predicted bid is below the second highest bid, the win probability is 0, otherwise it is a 1. For example, if the second highest bid is $3, a predicted bid of $2.99 gives a 0% chance of winning, while $3.01 gives a 100% chance of winning (assuming no ties). This sharp transition mimics a step. However, RTB auctions involve uncertainty and variability. Competitor bids are not fixed, but rather drawn from a distribution shaped by their algorithms, budgets, and targeting. Therefore, conventional ML models attempt to smooth the step function by estimating competitor bids as a probability density function (PDF), such as a lognormal or uniform distribution. The win probability then becomes a cumulative distribution function (CDF) of the second-highest bid. As a predicted bid increases, the chance of exceeding the unknown second-highest bid rises gradually, not instantly. For instance, bidding $2 might give a 20% chance, $3 a 50% chance, and $4 an 80% chance, depending on how bids are spread. This functional or distributional approach is challenging to evaluate and troubleshoot as win rates decrease or costs increase, particularly when integrated with other centralized optimization strategies.

Another technical challenge is that conventional ML models are typically trained on accepted bid data. For example, the training process for a ML model to predict the minimum bid price to win an RTB auction involves collecting a dataset of accepted (winning) bid prices from historical auctions, along with relevant features such as auction context (e.g., ad placement, user demographics, time of day), impression characteristics, and bidder information. The dataset is preprocessed to handle missing values, normalize features, and encode categorical variables. A supervised learning model, such as a regression model (e.g., gradient-boosted trees, neural networks), is trained to predict the winning bid price by minimizing a loss function (e.g., mean squared error) between predicted and actual winning bid prices. The model is validated using techniques like k-fold cross-validation to ensure generalization, with hyperparameter tuning performed via grid search or Bayesian optimization. The final model is deployed to predict the minimum bid price needed to win future auctions, potentially incorporating a small margin to account for uncertainty. However, training a model solely on winning bid prices introduces significant technical challenges, primarily due to selection bias and incomplete information. Since the dataset excludes losing bids, the model lacks visibility into the full distribution of bid prices, leading to biased predictions that may overestimate the minimum winning bid. This censored data problem, similar to survival analysis, prevents the model from learning the true market dynamics, such as the bid landscape or the behavior of competing bidders. Additionally, the absence of contextual information about losing bids (e.g., why they failed) limits the model's ability to generalize across diverse auction scenarios. This can result in suboptimal bidding strategies, where the model either overbids unnecessarily or fails to account for auctions with lower winning thresholds, reducing efficiency and increasing costs in RTB systems.

Embodiments implement technical solutions to these and other technical challenges using a multi-model architecture to generate a prediction of a minimum winning bid for an impression in an RTB auction. In some embodiments, for example, a DSP service implements the multi-model architecture that receives an input vector comprising bid request data associated with a bid request for an impression from a digital content exchange on behalf of a SSP. The multi-model architecture comprises a first ML model referred to as an accepted bid model. The multi-model architecture further comprises a second ML model referred to as a rejected bid model.

The accepted bid model is designed to generate a bid upper boundary value for a prediction interval based on the input vector. The accepted bid model is trained on a first set of training datapoints, wherein a first training datapoint comprises an accepted bid from a first set of auctions. Other features from the first training datapoint are selected to train the accepted bid model, such as a time of day, creative type, and audience segment. The accepted bid model uses regression techniques, such as linear regression or gradient boosting, to predict the bid upper boundary value.

The accepted bid model is an ML model trained to predict an upper boundary value for the minimum winning bid using historical data from accepted bids. An accepted bid is a bid that successfully won an auction. These accepted bids offer insight because they are known to be at least as high as the actual clearing price, though in many cases they may be significantly higher, especially in first-price auctions. The training data typically includes a wide array of features: the bid price, timestamp, auction type (first-price or second-price), user metadata (e.g., behavioral segments, interests), device and browser type, geographic location, publisher or inventory identifiers, ad slot characteristics (e.g., size, position), and contextual signals such as time of day, day of week, and page content. The core goal of the model is to estimate a high-confidence upper bound on the minimum bid needed to win similar auctions in the future, thereby identifying a price above which a bid is highly likely to win. This helps DSPs avoid unnecessary overbidding while still maintaining competitive participation. One approach is to use quantile regression to predict high percentiles (e.g., the 90th or 95th percentile) of observed winning bids for a given auction context. This technique allows the model to return a price point that is likely higher than the actual clearing price but still realistic and contextually appropriate. Alternatively, ensemble methods such as gradient-boosted trees (e.g., XGBoost, LightGBM) or neural networks can be trained to predict the winning bid directly and then adjusted with calibration techniques to account for market volatility or overbidding tendencies. In production, this model is deployed to score incoming bid requests in real time, generating a dynamic upper bound on what the winning price could be, given the current auction's attributes. This prediction can be used by buyers to cap their bids just below this upper limit, optimizing for cost efficiency, or by publishers to inform price floors or reserve pricing strategies. Over time, the model can be retrained using recent accepted bid data to adapt to market shifts such as seasonality, changes in advertiser behavior, or auction dynamics. This upper-bound prediction plays a key role in reducing bid shading risk, increasing budget efficiency, and improving ROI in programmatic advertising.

The rejected bid model is designed to generate a bid lower boundary value for the prediction interval based on the input vector. The rejected bid model is trained on a second set of training datapoints, wherein a second training datapoint comprises a rejected bid from a second set of auctions. Other features from the second training datapoint are selected to train the rejected bid model, such as a time of day, creative type, and audience segment. The rejected bid model uses classification or regression techniques, such as linear regression or gradient boosting, to predict the bid lower boundary value.

The rejected bid model is a machine learning model trained to predict a floor price for the minimum winning bid using historical data on rejected bids. A rejected bid is a bid that participated in RTB auctions but did not win. Although this data does not contain the exact winning price (which is often proprietary or unavailable), it offers lower bounds on a bid that was insufficient to win, which can be leveraged to infer a close approximation of the actual clearing price in second-price or first-price auction models. The data used for model training typically includes features such as bid amount, timestamp, user demographics or segments, device type (e.g., mobile vs desktop), geographic location, browser, publisher ID, ad slot size and position, page URL or content category, and contextual data such as time of day, day of week, or real-time user engagement signals. The core objective is to learn patterns in this high-dimensional feature space that correlate with the threshold between losing and winning. Because only rejected bids are observed, supervised learning techniques may be combined with probabilistic modeling or censored regression approaches (e.g., Tobit models) to account for the fact that the true floor price is unobserved but bounded below. Alternatively, a classification model can be trained to predict the likelihood of a bid being rejected at various price points, and the floor price can be inferred as the point where the rejection probability drops below a given threshold. Some implementations use quantile regression to directly estimate the price corresponding to a desired winning probability percentile (e.g., the 90th percentile of rejected bids). Over time, the model adapts to market conditions, learning that different segments or contexts support different price elasticity, such as highly competitive users or premium content slots typically demand higher floor prices. Once trained, the model is deployed in real time to score incoming impression requests and recommend a dynamic floor price based on current auction conditions. This empowers publishers or SSPs (Supply-Side Platforms) to set intelligent price floors that maximize revenue without deterring participation from DSPs, maintaining a balance between yield optimization and fill rate. Additionally, performance can be continuously monitored and refined using online learning or batch retraining as new auction data becomes available.

The bid upper boundary value from the accepted bid model and the bid lower boundary value from the rejected bid model form a prediction interval. The prediction interval reflects a range of candidate bid values, allowing for a more informed bidding strategy when responding to the bid request. Bid exploration logic selects a bid value from the range of candidate bid values of the prediction interval. The selected bid value represents a prediction of a minimum accepted bid needed to win the impression. The DSP service sends bid response data comprising the selected bid value, among other types of information, in response to the bid request to the digital content exchange.

To enhance the bidding strategy, an exploration parameter controls a level of exploration within the prediction interval. The bid exploration logic uses the exploration parameter to determine to bid closer to the upper boundary or the lower boundary based on current market conditions and competitive landscape. The DSP may implement a monitoring system to monitor SSPs, other DSPs, and/or digital content exchanges for real-time auction data. The bid exploration logic dynamically adjusts the exploration parameter based on the real-time auction data and performance metrics to optimize a balance between risk parameters and reward parameters.

In some embodiments, the accepted bid model and the rejected bid model are integrated into a single ML model. For example, an ML model is trained on both accepted and rejected bids. This provides a more comprehensive view of the auction dynamics compared to models trained solely on accepted bids. Each impression auction involves multiple bids, but most models are only trained on the winning bids, leading to selection bias. Including both accepted (winning) and rejected (losing) bids enables the model to learn about the full distribution of bid prices and contextual signals, allowing for improved estimation of win probabilities, bid shading strategies, or true market value of impressions.

One of the key challenges in using both accepted and rejected bids is that the true clearing price (i.e., the second-highest bid in second-price auctions) is often unobserved for rejected bids. This introduces censoring into the data. While it is known that a rejected bid was too low to win, it is unknown how close it was to actually winning the impression. In some embodiments, censored regression techniques are used to model this unknown variable. Examples include Tobit models or custom adaptations in neural networks. For instance, survival analysis methods can be applied, where the event of winning is treated like a “failure” event in a censored time-to-event model, and the loss function is designed to account for the fact that rejected bids only indicate that the market price was higher than the bid.

In some embodiments, the ML model uses a likelihood-based approach where accepted bids contribute full information (observed clearing price) and rejected bids contribute partial information (a lower bound on the clearing price). For example, a censored loss function is constructed where, for rejected bids, the model is penalized only if its predicted clearing price is below the bid price, enforcing a lower-bound constraint. Deep survival models, such as DeepHit or Cox proportional hazards adaptations, can also be adapted to estimate the conditional distribution of market prices given features, using both censored and uncensored data.

Training the ML model involves curating a dataset with auction-level features (e.g., user demographics, device type, time of day, publisher ID, bid amount) and tagging each bid as accepted or rejected. Careful normalization, stratification, and sampling is used to handle the heavy class imbalance. Once trained, the ML model can be used to estimate bid win probabilities, optimal bid pricing under budget constraints, or the marginal utility of impression contexts. By leveraging censored regression techniques, the model makes better use of incomplete auction outcomes, improving predictive power and overall bidding efficiency in competitive RTB environments.

In some embodiments, the accepted bid model and/or the rejected bid model are trained using a surrogate loss function. The surrogate loss function is designed to handle a regression problem with added penalties for specific cases. For example, the surrogate loss function incorporates a regular negative log-likelihood (NLL) loss, a regularization on a predicted variance (sigma), and an asymmetric penalization based on a relationship between a predicted mean (mu) and a set of true values (y_true). The loss is further adjusted depending on a value of an accepted bid, which signifies different penalty conditions.

Embodiments offer several technical advantages relative to conventional DSP services. For example, conventional DSP services implement a single ML model formulated as a proxy binary classification task, producing a functional estimation of win probabilities rather than a simple point estimate. This functional and/or distributional approach can be challenging to evaluate and troubleshoot, particularly when integrated with centralized optimization strategies. By implementing a multi-model approach, the DSP service predicts a minimum winning bid from a prediction interval comprising a range of candidate bid values defined using models tailored to predicting each boundary of the prediction interval. Further, conventional models typically avoid training on rejected bids since it is difficult to select features relevant to why the rejected bids failed to win the auctions. The multi-model approach trains the models using accepted bids, rejected bids, or a combination of accepted and rejected bids, using data from previous auctions. In addition, the models are trained using a surrogate loss function designed to handle a regression problem with added penalties for specific cases. The multi-model approach, particularly in combination with an exploration strategy, improves bidding efficacy in RTB. This allows digital content producers to better achieve campaign goals within a given set of resource constraints. This also allows the DSP service to win more auctions on behalf of digital content producers, while optimizing use of scarce technical resources such as computing, memory utilization, bandwidth, power, and maintenance. Other technical advantages exist as well.

### Detailed Embodiments

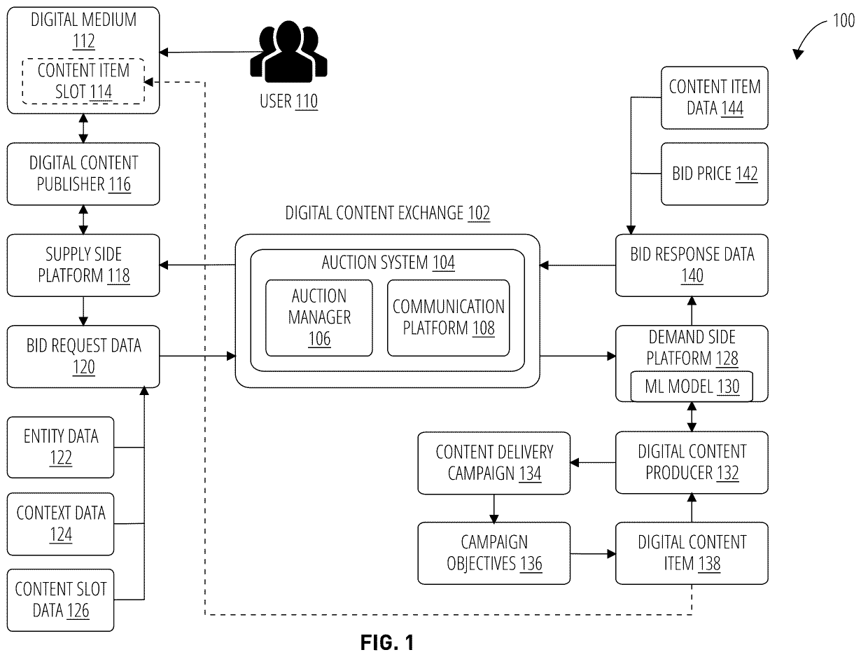

FIG. 1 illustrates an RTB system 100. The RTB system 100 is an example of an automated auction system engaging in a real-time bidding (RTB) auction between devices for digital content publishing entities and digital content producing entities. Embodiments are not limited to this example.

As depicted in FIG. 1, the RTB system 100 comprises a digital content exchange 102. The digital content exchange 102 implements an auction system 104 comprising an auction manager 106 and communication platform 108. The auction manager 106 manages RTB auctions. The communication platform 108 communicates information between devices in the RTB system 100.

The RTB system 100 is an automated auction system that enables the buying and selling of impressions in real-time (e.g., on the order of milliseconds). When a user 110 accesses a digital medium 112, such as a webpage or application, a digital content publisher 116 sends bid request data 120 through a supply side platform 118 to the digital content exchange 102. The bid request data 120 comprises entity data 122, context data 124, and content slot data 126 for an available content item slot 114 of the digital medium 112. The content item slot 114 is space on the digital medium 112 suitable for presenting a digital content item, such as digital content item 138, for a winning bid price. The digital content item 138 may comprise, for example, a creative such as an advertisement for a marketing campaign. When the content item slot 114 displays a digital content item 138 it creates an impression for the user 110 at the winning bid price.

The digital content exchange 102 receives the bid request data 120 from the supply side platform 118. The supply side platform 118 represents entities, such as publishers, offering impressions through a digital medium, such as an application, a website, a user interface, and so forth. The auction system 104 then initiates a RTB auction using the bid request data 120. The auction manager 106 of the auction system 104 distributes the bid request data 120 to one or more demand side platforms 128 via the communication platform 108. A demand side platform 128 represents one or more digital content producers 132 in the RTB auction, submitting bid response data 140 in response to the bid request data 120 on behalf of the digital content producers 132.

A digital content producer 132 engages in a content delivery campaign 134 designed to deliver digital content items 138 to users 110 as defined by one or more campaign objectives 136. The campaign objectives 136 may comprise parameters for hyperlocal targets, demographic targets, publisher targets, contextual targets, device targets, and so forth. The demand side platform 128 uses algorithms to determine when the bid request data 120 matches the campaign objectives 136 of the content delivery campaign 134, and it selects a digital content item 138 suitable for an impression offered by the bid request data 120.

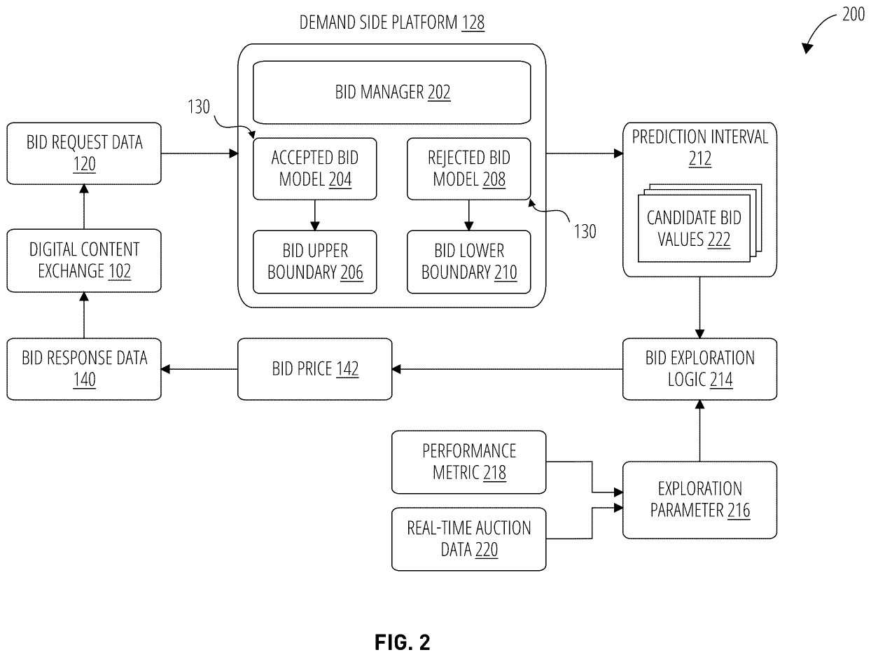

The demand side platform 128 generates bid response data 140 in response to the bid request data 120. The bid response data 140 includes, among other types of information, a bid price 142 and content item data 144 associated with the digital content item 138. The content item data 144 may include a type of digital content item 138, dimensions for the digital content item 138, and other types of metadata about the digital content item 138. An ML model 130 of the demand side platform 128 generates the bid price 142 for the bid response data 140. In some embodiments, the ML model 130 is implemented using a multi-model approach with an exploration strategy, as described in more detail with reference to FIG. 2.

Each demand side platform 128 submits bid response data 140 to the digital content exchange 102 in real-time via the communication platform 108. The auction manager 106 evaluates the bid prices 142, and it selects a winning bid based on the bid prices 142. For example, the auction manager 106 may implement a second-price auction model, where the highest bidder wins but pays just above the second-highest bid. For instance, if bids are $4 and $3, the winner pays $3.01.

The auction manager 106 notifies the demand side platform 128 when the bid response data 140 for the demand side platform 128 contains a winning bid. The demand side platform 128 sends the digital content item 138 to the digital content publisher 116 to publish the digital content item 138 in the content item slot 114 of the digital medium 112 for viewing by the user 110. This process results in the digital content item 138 appearing seamlessly as the digital medium 112 loads, tailored to the user 110, while remaining invisible to the user 110.

FIG. 2 illustrates a logic diagram 200. The logic diagram 200 is an example architecture for the demand side platform 128. Embodiments are not limited to this example.

As depicted in FIG. 2, the logic diagram 200 illustrates the demand side platform 128 comprising a bid manager 202 and a set of ML models 130. The ML models 130 comprise an accepted bid model 204 to generate a bid upper boundary 206 and a rejected bid model 208 to generate a bid lower boundary 210 for a prediction interval 212. Bid exploration logic 214 receives the prediction interval 212 comprising a range of candidate bid values 222 and an exploration parameter 216. The exploration parameter 216 is generated or modified using one or more performance metrics 218 and/or real-time auction data 220. For example, if the bid manager 202 instructs the set of ML models 130 to generate a bid price 142, and results of the auction indicate that the bid price 142 was a losing bid, the exploration parameter 216 is increased towards the bid upper boundary 206 for the next auction to increase a probability of a winning bid. Conversely, if the bid price 142 results in a winning bid, the exploration parameter 216 is decreased towards the bid lower boundary 210 for the next auction to reduce overbidding. In this manner, the exploration parameter 216 is a value indicating whether the bid exploration logic 214 should be biased towards selecting a bid price 142 from the range of candidate bid values 222 towards the bid upper boundary 206 or the bid lower boundary 210. The bid exploration logic 214 selects a bid price 142 from the candidate bid values 222 of the prediction interval 212 using the exploration parameter 216.

One purpose of the bid manager 202 is to predict a minimum accepted bid price needed to win an auction using historical outcomes from previous auctions. A minimum accepted bid price reduces costs for the digital content producer 132 generating the digital content item 138, thereby maximizing return on investment (ROI) by minimizing overbidding.

Overbidding affects some cost tiers more than others since overbidding in a lower cost tier of impressions has a greater percentage impact to the a budget allocated to that tier versus a higher cost tier of impressions. For example, an actual cost to win an auction is typically represented using a cost per mile (CPM) metric, which is a cost per 1000 impressions. The CPM depends on many factors, such as inventory type, competition, audience targeting, ad format, time of day, season, viewability and placement quality, position, and so forth. An example of inventory types and CPM range is shown in Table 1.

TABLE 1

| Inventory Type | CPM Range |
|---|---|
| Display (web/mobile) | $0.50-$5.00 |
| Video | $5.00-$25.00 |
| Native | $1.00-$6.00 |
| Social Media | $2.00-$10.00+ |
| Premium/Targeted Audience | $10.00-$50.00+ |

As shown in Table 1, different CPM ranges are associated with different inventory types. Each CPM range is referred to as a “cost bucket.” A cost bucket represents a range of costs for an impression. For example, display impressions costing $0.50 to $5.00 comprise a lower cost bucket, while premium impressions costing $10.00 to $50.00 comprise a higher cost bucket relative to the display impressions.

Overbidding has a greater amount of impact on budget allocation for lower cost buckets relative to higher cost buckets. Therefore, one use case for the bid manager 202 is to reduce overbidding for a lower tier cost bucket to optimize budget allocated for that cost bucket. For example, in a given time period, assume the demand side platform 128 receives an X number of auctions from the supply side platform 118, the demand side platform 128 generates a Y number of winning bids for impressions on behalf of the digital content producer 132, and a Z number of total fees was paid to the digital content exchange 102 for the winning bids. Further assume the Y number of winning bids for impressions are divided among 10 quantiles ranging from lower cost impressions to higher cost impressions. If the minimum accepted bid price wins a number of impressions greater than or equal to Y with a W number of total fees lower than Z in a lower quantile, then the costs for the digital content producer 132 are reduced for the same or greater number of impressions.

For example, assume on a given day there were a total of 2,366,519,970 invited auctions, the digital content producer 132 successfully won 141,882,255 of them, and the total fees paid to digital content exchange 102 for these wins amounted to $6,175,571. If the demand side platform 128 instead won impressions in lower-cost buckets while maintaining the same number of 141,882,255 impressions, the cost could have been reduced to just $1,254,637, thereby resulting in a cost reduction of over 70% for a same number of impressions.

A bid price bucket in descending order from highest percentile to lowest percentile is shown in Table 2.

TABLE 2

| mu_bucket | total_records | nImp_1_count | bucket_max | percentage_nImp_1 |
|---|---|---|---|---|
| 9.0 | 236651997 | 6758277 | 0.01584809 | 2.8557870145503146 |
| 8.0 | 235491524 | 9913883 | 0.01142697 | 4.209868292329706 |
| 7.0 | 235947799 | 11915489 | 0.010746707 | 5.0500530416051905 |
| 6.0 | 235422296 | 7402068 | 0.010518023 | 3.1441660903689423 |
| 5.0 | 235907392 | 23262445 | 0.010108116 | 9.860837679897712 |
| 4.0 | 235815305 | 15451434 | 0.010002083 | 6.552345701225796 |
| 3.0 | 235776642 | 14580569 | 0.009952729 | 6.1840599969186085 |
| 2.0 | 235532153 | 21935743 | 0.009559669 | 9.321760413746993 |
| 1.0 | 235544202 | 15494275 | 0.0093651125 | 6.578075311741276 |
| 0.0 | 235476314 | 15148072 | 0.009289627 | 6.432949345385115 |

Table 2 shows winning rates segmented into 10 equal percentiles based on minimumBidToWinPrice_bucket. While the minimumBidToWinPrice, similar to the deal floor price, does not always represent a lowest bid required to win, it provides useful insight into the pricing tier of different auctions. The data reveals sizable opportunities to win the same amount or even more impressions by winning more in the lower tier opportunities.

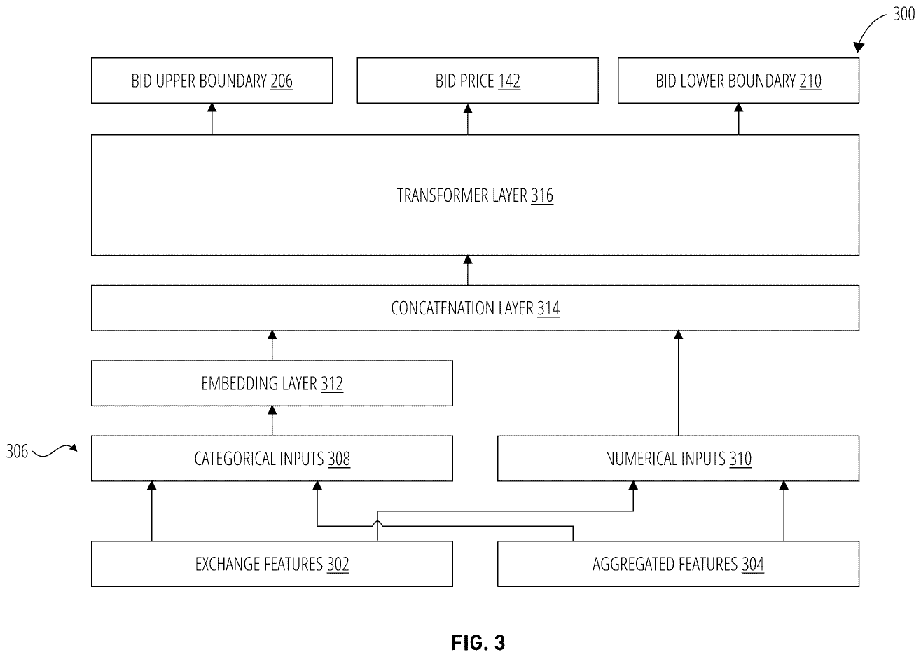

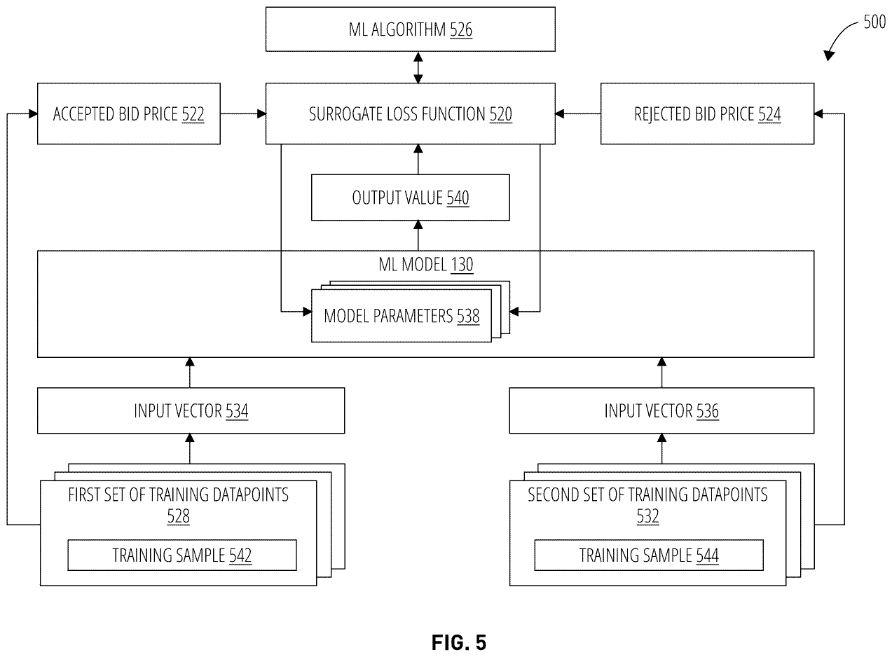

FIG. 3 illustrates an ML architecture 300. The ML architecture 300 is an example of a framework for the ML models 130, such as an accepted bid model 204 or a rejected bid model 208. Both the accepted bid model 204 and the rejected bid model 208 have similar architectures. However, the accepted bid model 204 is trained on accepted bid training data while the rejected bid model 208 is trained on rejected bid training data. An example of a training process for the accepted bid model 204 and the rejected bid model 208 is described with reference to FIG. 5.

The DSP service generates a bid value for an impression using multiple ML models 130. In some embodiments, for example, a DSP service implements the multi-model architecture that receives an input vector comprising bid request data associated with a bid request for an impression from a digital content exchange on behalf of a SSP. The multi-model architecture comprises a first ML model referred to as an accepted bid model 204. The multi-model architecture further comprises a second ML model referred to as a rejected bid model 208.

The accepted bid model 204 is designed to generate a bid upper boundary value for a prediction interval based on the input vector. The accepted bid model 204 is trained on a first set of training datapoints, wherein a first training datapoint comprises an accepted bid from a first set of auctions. Other features from the first training datapoint are selected to train the accepted bid model, such as a time of day, creative type, and audience segment. The accepted bid model 204 uses regression techniques, such as linear regression or gradient boosting, to predict the bid upper boundary value.

The accepted bid model 204 is an ML model 130 trained to predict an upper boundary value for the minimum winning bid using historical data from accepted bids. An accepted bid is a bid that successfully won an auction. These accepted bids offer insight because they are known to be at least as high as the actual clearing price, though in many cases they may be significantly higher, especially in first-price auctions. The training data typically includes a wide array of features: the bid price, timestamp, auction type (first-price or second-price), user metadata (e.g., behavioral segments, interests), device and browser type, geographic location, publisher or inventory identifiers, ad slot characteristics (e.g., size, position), and contextual signals such as time of day, day of week, and page content. The core goal of the model is to estimate a high-confidence upper bound on the minimum bid needed to win similar auctions in the future, thereby identifying a price above which a bid is highly likely to win. This helps DSPs avoid unnecessary overbidding while still maintaining competitive participation. One approach is to use quantile regression to predict high percentiles (e.g., the 90th or 95th percentile) of observed winning bids for a given auction context. This technique allows the model to return a price point that is likely higher than the actual clearing price but still realistic and contextually appropriate. Alternatively, ensemble methods such as gradient-boosted trees (e.g., XGBoost, LightGBM) or neural networks can be trained to predict the winning bid directly and then adjusted with calibration techniques to account for market volatility or overbidding tendencies. In production, this model is deployed to score incoming bid requests in real time, generating a dynamic upper bound on what the winning price could be, given the current auction's attributes. This prediction can be used by buyers to cap their bids just below this upper limit, optimizing for cost efficiency, or by publishers to inform price floors or reserve pricing strategies. Over time, the model can be retrained using recent accepted bid data to adapt to market shifts such as seasonality, changes in advertiser behavior, or auction dynamics. This upper-bound prediction plays a key role in reducing bid shading risk, increasing budget efficiency, and improving ROI in programmatic advertising.

The rejected bid model 208 is designed to generate a bid lower boundary value for the prediction interval based on the input vector. The rejected bid model 208 is trained on a second set of training datapoints, wherein a second training datapoint comprises a rejected bid from a second set of auctions. Other features from the second training datapoint are selected to train the rejected bid model, such as a time of day, creative type, and audience segment. The rejected bid model 208 uses classification or regression techniques, such as linear regression or gradient boosting, to predict the bid lower boundary value.

The rejected bid model 208 is an ML model 130 trained to predict a floor price for the minimum winning bid using historical data on rejected bids. A rejected bid is a bid that participated in RTB auctions but did not win. Although this data does not contain the exact winning price (which is often proprietary or unavailable), it offers lower bounds on a bid that was insufficient to win, which can be leveraged to infer a close approximation of the actual clearing price in second-price or first-price auction models. The data used for model training typically includes features such as bid amount, timestamp, user demographics or segments, device type (e.g., mobile vs desktop), geographic location, browser, publisher ID, ad slot size and position, page URL or content category, and contextual data such as time of day, day of week, or real-time user engagement signals. The core objective is to learn patterns in this high-dimensional feature space that correlate with the threshold between losing and winning. Because only rejected bids are observed, supervised learning techniques may be combined with probabilistic modeling or censored regression approaches (e.g., Tobit models) to account for the fact that the true floor price is unobserved but bounded below. Alternatively, a classification model can be trained to predict the likelihood of a bid being rejected at various price points, and the floor price can be inferred as the point where the rejection probability drops below a given threshold. Some implementations use quantile regression to directly estimate the price corresponding to a desired winning probability percentile (e.g., the 90th percentile of rejected bids). Over time, the model adapts to market conditions, learning that different segments or contexts support different price elasticity, such as highly competitive users or premium content slots typically demand higher floor prices. Once trained, the model is deployed in real time to score incoming impression requests and recommend a dynamic floor price based on current auction conditions. This empowers publishers or SSPs (Supply-Side Platforms) to set intelligent price floors that maximize revenue without deterring participation from DSPs, maintaining a balance between yield optimization and fill rate. Additionally, performance can be continuously monitored and refined using online learning or batch retraining as new auction data becomes available.

The bid upper boundary value from the accepted bid model and the bid lower boundary value from the rejected bid model form a prediction interval. The prediction interval reflects a range of candidate bid values, allowing for a more informed bidding strategy when responding to the bid request. Bid exploration logic selects a bid value from the range of candidate bid values of the prediction interval. The selected bid value represents a prediction of a minimum accepted bid needed to win the impression. The DSP service sends bid response data comprising the selected bid value, among other types of information, in response to the bid request to the digital content exchange.

The ML model 130 receives an input vector 306 with features from the bid request data 120, and it generates a single bid price 142 for the impression. This is an improvement over conventional models that produce a functional estimation, such as an estimated distribution of lognormal distribution parameterized by mu (μ) and sigma (σ), of win probabilities. This functional estimation approach can be challenging to evaluate and troubleshoot, particularly when integrated with centralized optimization strategies.

In various embodiments, depending on a particular training dataset used to train the ML model 130, the ML model 130 is trained to generate a bid upper boundary 206 for a prediction interval 212 based on an input vector 306 and a bid lower boundary 210 for the prediction interval 212 based on the input vector 306.

During inferencing operations, the accepted bid model 204 and the rejected bid model 208 receives an input vector 306 comprising a set of categorical inputs 308 and numerical inputs 310 from a set of exchange features 302 and aggregated features 304. Non-limiting examples of exchange features 302 include: (1) a bid floor price which is a minimum bid required to participate in the auction; (2) auction type which is first-price or second-price auction, impacting bidding strategy; (3) impression uniform resource locator (URL) category which is a content category of the creative placement (e.g., Sports, News); (4) content slot visibility such as whether the creative is above or below the fold; (5) a creative format such as a banner, video, native, CTV, and so forth; and/or (6) content slot placement position such as header, sidebar, inline, and so forth. Non-limiting examples of aggregated features 304 include user and device features, geo-location features, historical and aggregated features, and time and context features. User and device features include device type (e.g., mobile, desktop, tablet, CTV, etc.), operating system (e.g., iOS, Android, Windows, MacOS), browser type (e.g., Chrome, Safari, Firefox, Edge, etc.), and connection type (e.g., 4G, 5G, Wi-Fi, Fiber, etc.). Geo-location features include country, region, city, zipcode, auction location data, and time zone which is important for time-based bidding adjustments. Historical and aggregated features include historical winning bid price (e.g., past winning bids for similar auctions), historical bid acceptance rate (e.g., percentage of bids accepted historically), historical Click-Through Rate (CTR) (e.g., estimated likelihood of user clicking the creative, historical Conversion Rate (CVR) (e.g., probability of post-click conversion), aggregated bid competitiveness (e.g., average winning bid price for similar auctions), and zipcode-level bid price statistics (e.g., mean and variance of winning bid prices in the same area. Time and context features include hour of the day, day of the week (e.g., captures daily/weekly bidding trends, and seasonality factor (e.g., holiday sales, Black Friday, special events affecting demand).

The ML architecture 300 receives the exchange features 302 and aggregated features 304, and it transforms the features into categorical inputs 308 and numerical inputs 310 for the input vector 306. For categorical inputs 308, the features are transformed from raw data into discrete categories using techniques such as label encoding, one-hot encoding, binning numerical features, thresholding, text to categorical (e.g., sentiment), handling rare categories, or target encoding. For numerical inputs 310, the features are transformed from raw data into numerical data using techniques such as label encoding for categorical features, one-hot encoding for nominal categories, ordinal encoding, frequency or count encoding, target encoding, transforming text features (e.g., bag of words, TF-IDF, word embeddings), datetime features, scaling or normalizing numerical features, handling missing values, or feature engineering (e.g., creating new numerical features from non-numerical ones).

Once transformed, the categorical inputs 308 are further processed by an embedding layer 312. The embedding layer 312 is a specialized layer that transforms discrete, categorical inputs (e.g., words, tokens, or IDs) into dense, continuous numerical vectors called embeddings. The embedding layer 312 captures semantic relationships or meaningful patterns in the categorical inputs 308.

A concatenation layer 314 concatenates the output of the embedding layer 312 and the numerical inputs 310 to create a concatenated vector. The concatenation layer 314 outputs the concatenated vector to a transformer layer 316.

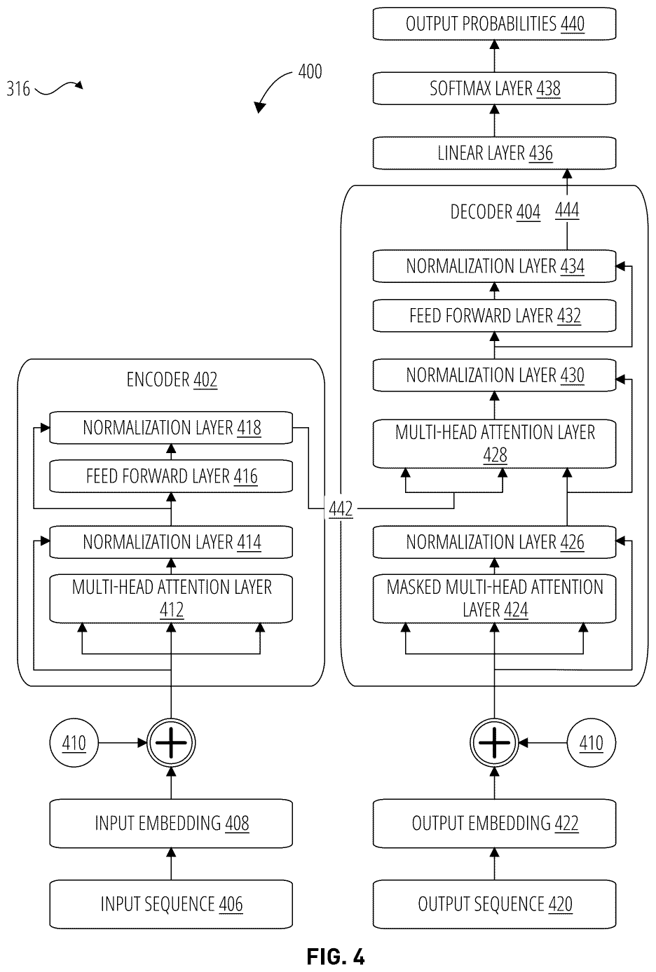

The transformer layer 316 receives the concatenated vector, and it processes it through a transformer architecture to output a value. The transformer layer 316 uses various layers to implement various regression techniques, such as linear regression or gradient boosting, to predict the output value. The transformer layer 316 processes the concatenated vector as a whole, rather than sequentially, using self-attention to weigh the importance of different parts of the input when producing an output. This allows it to capture relationships between distant elements efficiently. An example of a transformer architecture for the transformer layer 316 is described in more detail with reference to FIG. 4.

FIG. 4 illustrates a transformer model 400. The transformer model 400 is an example of a transformer architecture suitable for use by the transformer layer 316. Embodiments are not limited to this example.

As depicted in FIG. 4, the transformer model 400 comprises an encoder 402 and a decoder 404. The encoder 402 receives as input an input sequence 406, which is converted to an input embedding 408. A positional encoding 410 is added to the input embedding 408. The input embedding 408 with positional encoding 410 is input to the encoder 402. The encoder 402 comprises a multi-head attention layer 412, a normalization layer 414, a feed forward layer 416, and a normalization layer 418. The encoder 402 outputs an encoder output 442 to the decoder 404. The decoder 404 receives as input an output sequence 420, which is converted to an output embedding 422. A positional encoding 410 is added to the output embedding 422. The output embedding 422 with positional encoding 410 is input to the decoder 404. The decoder 404 comprises a masked multi-head attention layer 424, a normalization layer 426, a multi-head attention layer 428, a normalization layer 430, a feed forward layer 432, and a normalization layer 434.

Specifically, the encoder 402 is a neural sequence transduction model comprising an encoder 402 and a decoder 404. The encoder 402 receives an input sequence 406 and it translates the input sequence 406 into a lower-dimensional space. The encoder 402 maps an input sequence of symbol representations (x₁, . . . , xₙ) to a sequence of continuous representations z=(z₁, . . . , Zₙ). Given z, the decoder 404 then generates an output sequence (y₁, . . . , yₘ) of symbols one element at a time. At each step, the model is auto-regressive, consuming the previously generated symbols as additional input when generating the next. The decoder 404 translates the lower-dimensional data provided by the encoder 402 back to the original data format. Both the encoder 402 and the decoder 404 share three main types of layers, including a positional encoding layer, self-attention layer, and feedforward layer.

The encoder 402 transforms natural language input into numerical vectors. The encoder 402 receives an input sequence 406. The input sequence is a sequence of tokens (e.g., words or sub-words) that represent the text input. An input encoding layer of the encoder 402 converts the input sequence 406 into an input embedding 408. An input embedding 408 is a numerical representation of concepts converted to number sequences. The input embedding 408 is an NLP technique that represents words with vectors in such a way that once represented in a vectorial space, the mathematical distance between vectors is representative of the similarity among words they represent. For example, the content delivery application 920 may incorporate input embeddings to personalize, recommend, and search content. The input embedding 408 may comprise a matrix of vectors, where each vector represents a token in the sequence. The input embedding layer maps each token to a high-dimensional vector that captures the semantic meaning of the token.

Positional encoding 410 is a fixed, learned vector that represents a position of a word in the input sequence. It is added to the input embedding 408 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 408. The positional encoding is a vector that represents the position of each token in the sequence.

The encoder 402 includes multiple self-attention layers. The self-attention layers are responsible for determining the importance of each input token in generating the output. The self-attention layer allows the model to compute relationships between different parts of the input sequence 406. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 402 uses a multi-head attention layer 412. The multi-head attention layer 412 uses multiple self-attention layers operating in parallel on different parts of the input data, producing multiple representations. The multi-head attention layer 412 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 416.

The feed forward layer 416 comprises a series of fully connected layers and activation functions. The feed forward layer 416 transforms the output of the multi-head attention layer 412 into a suitable representation for the final output. The feed forward layer 416 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a ReLu. The output of the feed forward layer 416 is used as input to the next layer in the encoder 402.

The encoder 402 may also comprise a number of normalization layers, such as a normalization layer 414 and a normalization layer 418. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 418 is the final output from the encoder 402 and it is a vector representation of the input sequence 406. The final output from the normalization layer 418 is used as input to the multi-head attention layer 428 of the decoder 404.

The decoder 404 decodes the input sequence 406 to the original data format. Similar to the encoder 402, the decoder 404 shares the core elements of positional encoding, self-attention, and feedforward layers. As depicted in transformer model 400, the decoder 404 comprises a masked multi-head attention layer 424, a normalization layer 426, a multi-head attention layer 428, a normalization layer 430, a feed forward layer 432, and a normalization layer 434. The decoder 404 outputs a decoder output 444 to a linear layer 436. The linear layer 436 is a feedforward network that adapts the dimension of the input to the dimension of the output. The output of the linear layer 436 feeds into a softmax layer 438. The softmax layer 438 transforms the input into a vector of probabilities. The output of the softmax layer 438 is a set of an output probabilities 440 for the transformer model 400. The transformer model 400 then picks the word corresponding to the highest probability and uses it as a best output of the model.

FIG. 5 illustrates a training system 500. The training system 500 is an example of components to train an ML model 130 such as the ML architecture 300. Embodiments are not limited to this example.

As depicted in FIG. 5, the training system 500 trains an ML model 130 using an ML algorithm 526 to perform various tasks. An ML algorithm 526 is a procedure or set of rules used to learn patterns from data and make predictions or decisions. It is a general method or recipe that defines how to find a solution to a problem, typically by optimizing some objective (e.g., minimizing error). Examples of ML algorithm 526 include linear regression to fit a line by minimizing the sum of squared errors, a decision tree that splits data based on feature thresholds to maximize information gain, a gradient descent that iteratively updates parameters to minimize a loss function, a K-means clustering that assigns points to clusters by minimizing intra-cluster distances, and backpropagation that updates neural network weights based on gradients of the loss. The ML algorithm 526 takes as input the the raw data, such as features and possibly labels, and learns relationships by optimizing parameters or structure.

In some embodiments, the ML algorithm 526 trains the ML model 130 using a surrogate loss function 520. The surrogate loss function 520 is designed to handle a regression problem with added penalties for specific cases. For example, the surrogate loss function incorporates a regular negative log-likelihood (NLL) loss, a regularization on a predicted variance (o), and an asymmetric penalization based on a relationship between a predicted mean (u) and a set of true values (y_true). The loss is further adjusted depending on a value of an accepted bid, which signifies different penalty conditions. The surrogate loss function 520 is discussed in more detail with respect to the training iterations described further below.

In some embodiments, the ML algorithm 526 trains multiple ML models 130, such as the accepted bid model 204 and the rejected bid model 208. The accepted bid model 204 is designed to generate a bid upper boundary 206 value for a prediction interval 212 based on the input vector 306. The accepted bid model 204 is trained on a first set of training datapoints 528, wherein a first training datapoint comprises an accepted bid price 522 from a first set of auctions. The rejected bid model 208 designed to generate a bid lower boundary 210 value for the prediction interval 212 based on the input vector 306. The rejected bid model 208 is trained on a second set of training datapoints 532, wherein a second training datapoint comprises a rejected bid price 524 from a second set of auctions. In some embodiments, the first set of auctions and the second set of auctions are non-exclusive and comprise different auctions. In some embodiments, the first set of auctions and the second set of auctions overlap. The latter case may occur when there is a training dataset comprising both accepted bid prices 522 and rejected bid prices 524 for a given set of auctions.

In some embodiments, the accepted bid model 204 and the rejected bid model 208 are separate ML models 130 each using the ML architecture 300. In this case, the accepted bid model 204 and the rejected bid model 208 generate the bid upper boundary 206 and the bid lower boundary 210, respectively, as outputs to the bid exploration logic 214. The bid exploration logic 214 selects the final bid price 142 using the exploration parameter 216.

In some embodiments, the accepted bid model 204 and the rejected bid model 208 are part of a single ML model 130. For example, the single ML model 130 is trained on both the first set of training datapoints 528 and the second set of training datapoints 532. In this case, the single ML model 130 outputs the prediction interval 212 with the range of candidate bid values 222 as outputs to the bid exploration logic 214. The bid exploration logic 214 selects the final bid price 142 using the exploration parameter 216.

In some embodiments, the accepted bid model 204, the rejected bid model 208, and the bid exploration logic 214 are part of a single ML model 130. For example, the single ML model 130 is trained on both the first set of training datapoints 528 and the second set of training datapoints 532. Further the bid exploration logic 214 is implemented as a layer of the single ML model 130. In this case, the output of the single ML model 130 is the final bid price 142.

The training system 500 trains an ML model 130 over a set of training iterations. A training iteration comprises retrieving a training sample 542 from a training dataset, such as the first set of training datapoints 528. The training sample 542 comprises a set of features and a target label, the set of features similar to the exchange features 302 and aggregated features 304 of the input vector 306, and the target label comprising an accepted bid price 522. The training system 500 generates an input vector 306 from the set of features of the training sample 542. The ML model 130 receives the ML model 130, and it generates an output value 540 from the input vector 306 using the transformer layer 316, such as transformer model 400. The output value 540 may comprise the bid lower boundary 210 value. A surrogate loss function 520 computes a loss value between the output value 540 from the ML model 130 and the target label, which in this case is the accepted bid price 522. The training system 500 calculates gradients of the loss value for a set of model parameters 538 for the ML model 130. The training system 500 adjusts the model parameters 538 for the ML model 130 based on the gradients using an optimization algorithm. The training system 500 selects another training sample 542 from the training dataset, and it performs another training iteration on the new training sample 542.

The training system 500 continues the training process for the set of training iterations. The training system 500 calculates a number of training iterations for the set of training iterations based on a batch size and a total number of training samples 542 in the training dataset. The training system 500 trains the ML model 130 using batches of training samples of the batch size for the number of training iterations. The training system 500 increments a counter for an epoch indicating the number of training iterations is complete. The training system 500 then randomizes an order of the training samples 542 in the training dataset, and it repeats the set of training iterations for a set of epochs defined by a hyperparameter for the ML model 130. Once the set of epochs is complete, the ML model 130 becomes an ML algorithm 526.

The training system 500 performs similar training operations for the rejected bid model 208. The training system 500 also performs similar training operations for a unified ML model 130 comprising the accepted bid model 204, the rejected bid model 208, and/or the bid exploration logic 214.

The training system 500 trains the ML model 130 using a surrogate loss function 520. The surrogate loss function 520 is designed to handle a regression problem with added penalties for specific cases. For example, the surrogate loss function incorporates a regular negative log-likelihood (NLL) loss, a regularization on a predicted variance (o), and an asymmetric penalization based on a relationship between a predicted mean (u) and a set of true values (y_true). The loss is further adjusted depending on a value of an accepted bid, which signifies different penalty conditions.

The NLL loss of the loss function 320 computes a likelihood of a true value under a normal distribution parameterized by mu (μ), which is a log of predicted mean, and sigma (σ), which is a log of predicted standard deviation. This allows for prediction uncertainty, where the log-transformed true values (y_true_log) are compared against the predicted distribution.

The regularization on a predicated variance (c) prevents sigma from becoming excessively large by applying an L2 regularization term. The strength of this regularization is controlled by a parameter regularization_strength. This term penalizes large values of sigma to avoid overconfidence in the model's uncertainty estimation.

To further constrain the predicted standard deviation, a sigma-mu ratio penalty is added when sigma becomes too large in relation to mu. This term helps ensure that the variance (c) remains reasonably small compared to the predicted mean (u).

An asymmetric penalty function includes two different penalty scenarios based on the value of a parameter referred to as “nimp.” If a bid is an accepted bid price 522 then nimp is set to a binary value of 1. If a bid is a rejected bid price 524 then nimp is set to a binary value of 0. For accepted bids, the loss function 320 aims to systematically explore if a lower bid could have still won the auction. For rejected bids, the loss function 320 estimates a media cost required to win those auctions, and then works towards determining a lowest possible bid that could secure a win.

The binary value of nimp affects how the penalties are applied. For example, when nimp is set to 1, a penalty is applied when the predicted mean (u) is greater than the true value (y_true_log). This “over-prediction” is penalized proportionally to the difference between mu and y_true_log, scaled by the NLL value and the label_penalty_strength. When nimp is set to 0, a heavier penalty is applied when the predicted mean (μ) is less than the true value (y_true_log), known as “under-prediction.” The penalty is larger in this case, controlled by heavier_nimp_0_penalty, as the model should be more cautious about underestimating.

A final loss is a combination of the NLL loss, the penalties based on over/under-prediction, the L2 regularization on sigma, and the sigma-mu ratio penalty. This total loss encourages the ML model 130 to provide accurate predictions with well-calibrated uncertainty, while applying additional penalties when specific conditions (over-prediction or under-prediction) occur.

An example of pseudo-code for the loss function 320 is as follows:

### Pseudo-Code Example

```
class NLLLoss:
  initialize with:
    - regularization_strength
    - sigma_mu_ratio_penalty
    - label_penalty_strength
    - heavier_nimp_0_penalty
  function compute_loss(y_true, y_pred):
    - Extract mu, sigma, and nimp from y_pred
    - Transform y_true to log-space: y_true_log = log(y_true)
    - Compute negative log-likelihood (NLL):
      nll = 0.5 * log(2 * pi * sigma\hat{ }2) + ((y_true_log − mu)\hat{ }2) / (2 *
      sigma\hat{ }2)
    - Apply L2 regularization on sigma:
      l2_reg = regularization_strength * sigma\hat{ }2
    - Enforce sigma constraint (sigma <= 0.05 * mu):
      ratio_penalty = sigma_mu_ratio_penalty * max(0, sigma − 0.05 *
      mu)
    - If nimp == 1 and mu > y_true_log:
      - Apply penalty for over-prediction:
      over_predict_penalty = label_penalty_strength * (mu −
      y_true_log) * nll
    - If nimp == 0 and mu < y_true_log:
      - Apply heavier penalty for under-prediction:
      under_predict_penalty = heavier_nimp_0_penalty *
label_penalty_strength * (y_true_log − mu) * nll
    - Compute total asymmetric penalty:
      asymmetric_penalty = over_predict_penalty +
      under_predict_penalty
    - Compute total loss:
      total_loss = nll + 12_reg + ratio_penalty + asymmetric_penalty
    return total_loss
```

A set of evaluation metrics for censored data in bid predictions is used to evaluate performance of the ML model 130 when predicting a minimum accepted bid. Given the nature of the training data, which is either right-censored (for accepted bid prices 522) or left-censored (for rejected bid prices 524), traditional regression metrics such as Mean Absolute Error (MAE) and Root Mean Squared Error (RMSE) are not directly applicable due to the absence of ground-truth values for the rejected bid prices 524. However, these concepts are adapted to create metrics that are relevant to this specific context. Various metrics are utilized to evaluate the performance of the ML model 130 predicting the minimum accepted bid.

A first metric is a proportion of positive predictions. This metric assesses the fraction of predicted bids (u) that are higher than the final bid price (bidPriceFinal) within the set of rejected bids. This is calculated as a Proportion=Count (μ>bidPriceFinal) Total Count of Negative SetProportion=Total Count of Negative SetCount (μ>bidPriceFinal).

A second metric is an average distance. An average difference between the predicted bid (μ) and the final bid price (bidPriceFinal) for the rejected bids is calculated, without taking the absolute value. This provides insight into how much lower the predicted values are relative to the actual bids.

A third metric is MAE, RMSE, and/or ME for accepted bid prices 522. For accepted bid prices 522, traditional metrics are applied when there are ground-truth values. For example, MAE measures the average absolute difference between predicted bids (u) and the final accepted bids, RMSE measures the root mean squared difference, and Mean Error (ME) provides insight into the bias of predictions (positive or negative).

A fourth metric is a ratio of the predicted bid (μ) to the ML model 130 output standard deviation (σ), ratio=μ/σ. A higher ratio indicates that the model's predictions are less noisy and more reliable.

By utilizing these customized metrics, valuable insights are gained into the performance of our minimum accepted bid prediction model, effectively addressing the unique challenges posed by censored data.

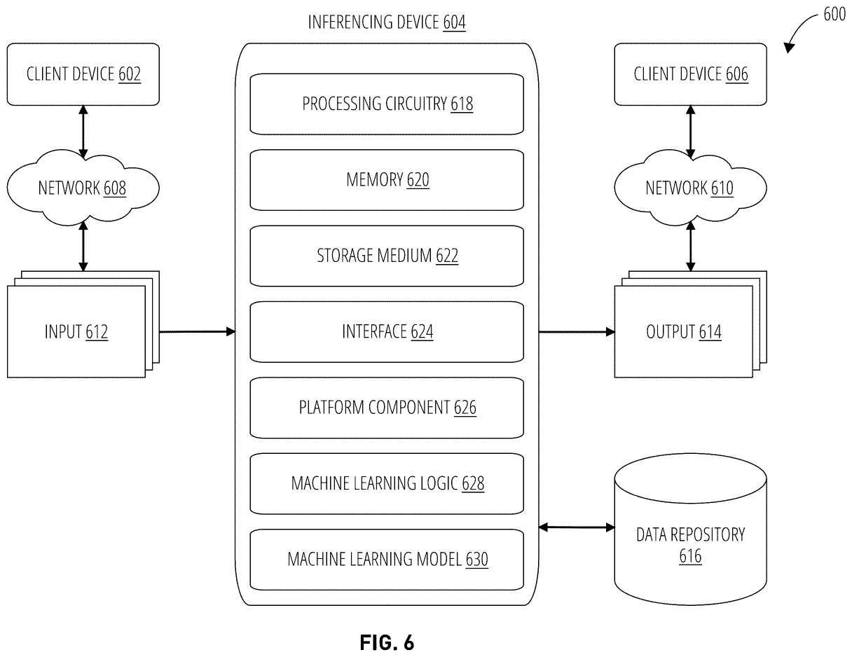

FIG. 6 illustrates an embodiment of a system 600. The system 600 is suitable for implementing one or more embodiments as described herein. In one embodiment, for example, the system 600 is an AI/ML system suitable for implementing models described with reference to any of the preceding description.

The system 600 comprises a set of M devices, where M is any positive integer. FIG. 6 depicts three devices (M=3), including a client device 602, an inferencing device 604, and a client device 606. The inferencing device 604 communicates information with the client device 602 and the client device 606 over a network 608 and a network 610, respectively. The information may include input 612 from the client device 602 and output 614 to the client device 606, or vice-versa. In one alternative, the input 612 and the output 614 are communicated between the same client device 602 or client device 606. In another alternative, the input 612 and the output 614 are stored in a data repository 616. In yet another alternative, the input 612 and the output 614 are communicated via a platform component 626 of the inferencing device 604, such as an input/output (I/O) device (e.g., a touchscreen, a microphone, a speaker, etc.).

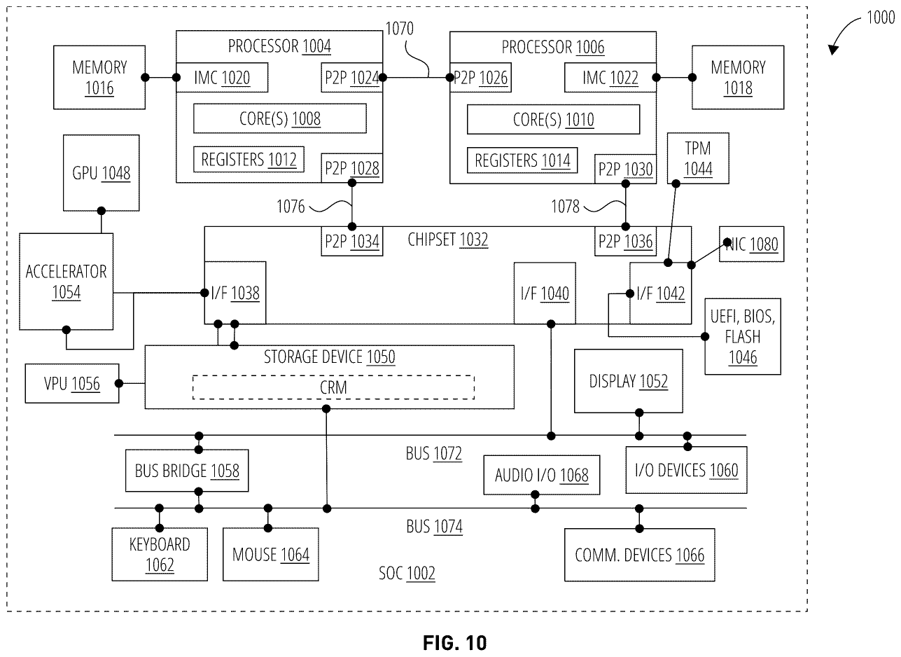

As depicted in FIG. 6, the inferencing device 604 includes processing circuitry 618, a memory 620, a storage medium 622, an interface 624, a platform component 626, ML logic 628, and an ML model 630. In some implementations, the inferencing device 604 includes other components or devices as well. Examples for software elements and hardware elements of the inferencing device 604 are described in more detail with reference to a computing architecture 1000 as depicted in FIG. 10. Embodiments are not limited to these examples.

The inferencing device 604 is generally arranged to receive an input 612, process the input 612 via one or more AI/ML techniques, and send an output 614. The inferencing device 604 receives the input 612 from the client device 602 via the network 608, the client device 606 via the network 610, the platform component 626 (e.g., a touchscreen as a text command or microphone as a voice command), the memory 620, the storage medium 622 or the data repository 616. The inferencing device 604 sends the output 614 to the client device 602 via the network 608, the client device 606 via the network 610, the platform component 626 (e.g., a touchscreen to present text, graphic or video information or speaker to reproduce audio information), the memory 620, the storage medium 622 or the data repository 616.

The inferencing device 604 includes ML logic 628 and an ML model 630 to implement various AI/ML techniques for various AI/ML tasks. The ML logic 628 receives the input 612, and processes the input 612 using the ML model 630. The ML model 630 performs inferencing operations to generate an inference for a specific task from the input 612. In some cases, the inference is part of the output 614. The output 614 is used by the client device 602, the inferencing device 604, or the client device 606 to perform subsequent actions in response to the output 614.

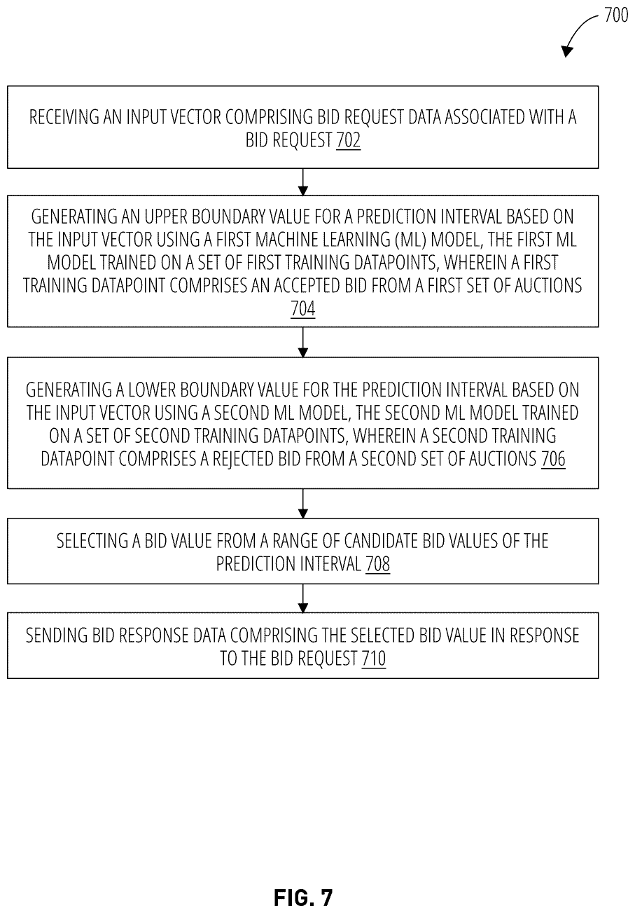

FIG. 7 illustrates an embodiment of a logic flow 700. The logic flow 700 may be representative of some or all of the operations executed by one or more embodiments described herein. For example, the logic flow 700 may include some or all of the operations performed by devices or entities to execute RTB system 100, logic diagram 200, ML architecture 300, transformer model 400, training system 500, and/or system 600.

As depicted in logic flow 700, at block 702, the logic flow 700 includes receiving an input vector comprising bid request data associated with a bid request. At block 704, the logic flow 700 includes generating a bid upper boundary value for a prediction interval based on the input vector using a first machine learning (ML) model, the first ML model trained on a first set of training datapoints, wherein a first training datapoint comprises an accepted bid from a first set of auctions. At block 706, the logic flow 700 includes generating a bid lower boundary value for the prediction interval based on the input vector using a second ML model, the second ML model trained on a second set of training datapoints, wherein a second training datapoint comprises a rejected bid from a second set of auctions. At block 712, the logic flow 700 includes selecting a bid value from a range of candidate bid values of the prediction interval. At block 708, the logic flow 700 includes sending bid response data comprising the selected bid value in response to the bid request.

By way of example, a demand side platform 128 receives bid request data 120 from a digital content exchange 102. The bid manager 202 sends control directives to the accepted bid model 204 and the rejected bid model 208 to generate a bid upper boundary 206 and a bid lower boundary 210 for a prediction interval 212, where the prediction interval 212 comprises a set of candidate bid values 222. Bid exploration logic 214 receives the prediction interval 212 and an exploration parameter 216, and it selects a bid price 142 from the candidate bid values 222 from the prediction interval 212 based on the exploration parameter 216. The bid exploration logic 214 attempts to select a bid price 142 that is a minimum bid value likely to win the impression identified in the bid request data 120. The exploration parameter 216 is set based on a performance metric 218 and real-time auction data 220, and it controls whether the bid exploration logic 214 selects the bid price 142 closer to the bid upper boundary 206 or the bid lower boundary 210. The bid price 142 is added to other types of data, such as data about a content item for the impression, as bid response data 140. The demand side platform 128 sends the bid response data 140 to the digital content exchange 102 in order to participate in, and win, the auction.

Specifically, a set of exchange features 302 and aggregated features 304 are retrieved from the bid request data 120, among other types of data, to generate an input vector 306 of categorical inputs 308 and numerical inputs 310 representing the bid request data 120. The accepted bid model 204 generates a bid upper boundary 206 value for a prediction interval 212 based on the input vector 306. The accepted bid model 204 is trained on first set of training datapoints 528, wherein a first training datapoint comprises an accepted bid price 522 from a first set of auctions. The rejected bid model 208 generates a bid lower boundary 210 value for the prediction interval 212 based on the input vector 306. The rejected bid model 208 is trained on a second set of training datapoints 532, wherein a second training datapoint comprises a rejected bid price 524 from a second set of auctions. The bid exploration logic 214 receives the prediction interval 212, and it selects a bid price 142 from a range of candidate bid values 222 of the prediction interval 212. The bid manager 202 packages the bid price 142, along with other data, into bid response data 140. The demand side platform 128 sends the bid response data 140 comprising the selected bid price 142 in response to the bid request data 120.

In some embodiments, for example, the demand side platform 128 receives the bid request data 120 from a digital content exchange 102 for a real-time bidding (RTB) auction, the bid request data 120 associated with a request for a bid on an available content item slot 114 of a digital medium 112, the bid request data comprising entity data 122, context data 124, or content slot data 126.

In some embodiments, for example, the demand side platform 128 sends the bid response data 140 to the digital content exchange for the RTB auction in response to a request for a bid on an available content item slot 114 of a digital medium 112, the bid response data 140 comprising the selected bid price 142 and content item data 144 for a digital content item 138 to present in the content item slot 114 of the digital media 112.

In some embodiments, for example, the bid manager 202 and/or the bid exploration logic 214 generates an exploration parameter 216 that controls a level of exploration within the prediction interval 212 based on real-time auction data 220 and a performance metric 218. The bid exploration logic 214 selects a bid price 142 value from the range of candidate bid values 222 based, at least in part, on the exploration parameter 216.

In some embodiments, for example, the bid exploration logic 214 generates a score for each candidate bid value in the range of candidate bid values 222 within the prediction interval 212, the score representing a probability of the candidate bid value winning the bid to present a digital content item 138 in a content item slot 114 of a digital medium 112. The bid exploration logic 214 selects the bid value from the range of candidate bid values based on the score.

In some embodiments, for example, the selected bid price 142 value comprises a predicted minimum accepted bid price for a tier of bid values within a set of tiers ordered by value.

In some embodiments, for example, the training system 500 trains the accepted bid model 204 on a first set of first set of training datapoints 528, wherein a first training datapoint comprises an accepted bid price 522 from a first set of auctions.

In some embodiments, for example, the training system 500 trains the second ML model on a second set of first set of training datapoints 528, wherein a second training datapoint comprises a rejected bid price 524 from the second set of auctions.

In some embodiments, for example, the training system 500 trains the first ML model or the second ML model on a first set of training datapoints 528 and a second set of training datapoints 532, wherein a first training datapoint comprises an accepted bid price 522 from the first set of auctions and a second training datapoint comprises a rejected bid price 524 from the second set of auctions.

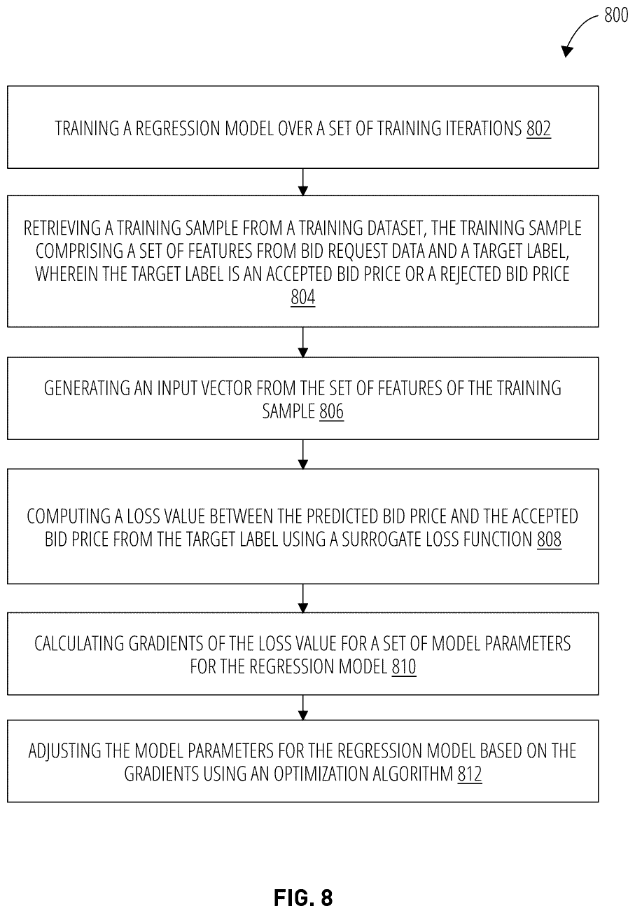

FIG. 8 illustrates an embodiment of a logic flow 800. The logic flow 800 may be representative of some or all of the operations executed by one or more embodiments described herein. For example, the logic flow 800 may include some or all of the operations performed by devices or entities to execute RTB system 100, logic diagram 200, ML architecture 300, transformer model 400, training system 500, system 600, and/or logic flow 700. In particular the

As depicted in logic flow 800, at block 802, the logic flow 800 includes adjusting the model parameters for the regression model based on the gradients using an optimization algorithm. At block 804, the logic flow 800 includes retrieving a training sample from a training dataset, the training sample comprising a set of features from bid request data and a target label, wherein the target label is an accepted bid price or a rejected bid price. At block 806, the logic flow 800 includes generating an input vector from the set of features of the training sample. At block 808, the logic flow 800 includes computing a loss value between the predicted bid price and the accepted bid price from the target label using a surrogate loss function. At block 810, the logic flow 800 includes calculating gradients of the loss value for a set of model parameters for the regression model. At block 812, the logic flow 800 includes adjusting the model parameters for the regression model based on the gradients using an optimization algorithm.

By way of example, the training system 500 uses ML algorithm 526 to train an ML model 130, such as an accepted bid model 204, a rejected bid model 208, or a combination of the accepted bid model 204 and the rejected bid model 208 as described with reference to FIG. 5. In some embodiments, for example, the training system 500 uses the ML algorithm 526 to train the ML model 130 using a surrogate loss function 520. The surrogate loss function 520 comprises a combination of a negative log-likelihood (NLL) loss function, a regularization on a predicted variance, and an asymmetric penalization based on a relationship between a predicted mean and a set of true values. The NLL loss function computes a likelihood of a true value from the set of true values under a normal distribution parameterized by the predicted mean and the predicted variance. The surrogate loss function 520 applies a regularization term to the predicted variance controlled by a regularization strength value. The surrogate loss function 520 adds a penalty value to the predicted variance when the predicted variance exceeds a defined threshold value in relation to the predicted mean. For instance, the surrogate loss function 520 applies a first penalty value when the predicted mean is greater than a true value from the set of true values or a second penalty value when the predicted mean is less than the true value, and the first penalty value is less than the second penalty value.

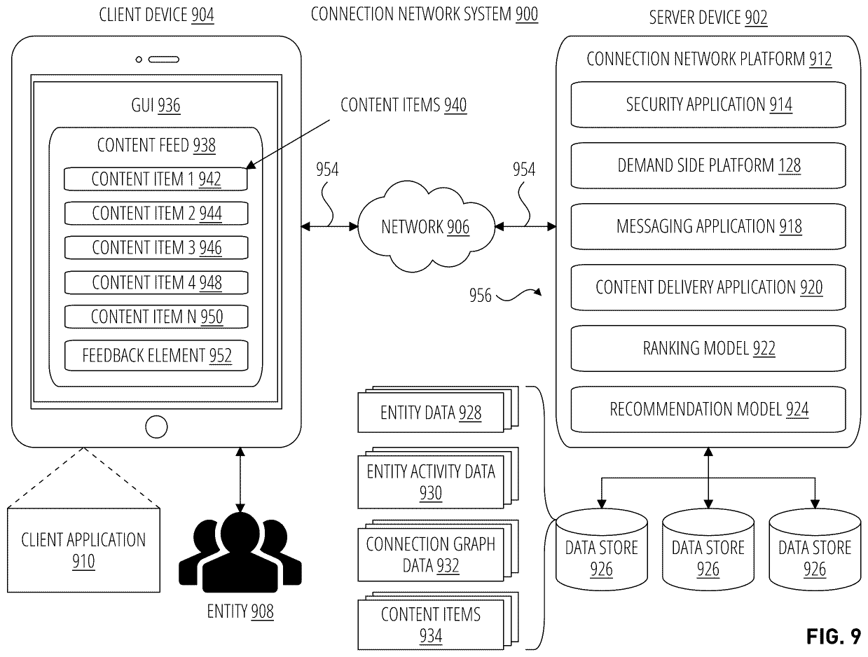

FIG. 9 illustrates a connection network system 900. The connection network system 900 is an example of an architecture or framework for an online computer and communications system designed to serve content items to an electronic device associated with a user. Embodiments are not limited to this example.

In general, the connection network system 900 may include a variety of servers, sub-systems, programs, modules, logs, and data stores. In particular embodiments, the connection network system 900 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 900 may also include suitable components such as network interfaces, security mechanisms, load balancers, failover servers, management-and-network-operations consoles, privacy software, and other suitable components, or any suitable combination thereof.

As depicted in FIG. 9, the connection network system 900 comprises a server device 902 communicating with a client device 904 over a network 906. Additionally, or alternatively, the client device 904 may communicate with another client device 904 in a peer-to-peer (P2P) mode or via the server device 902. In operation, an entity 908 interacts with a client application 910 of the client device 904 to access applications and services provided by a connection network platform 912 of the server device 902. The connection network platform 912 offers a number of network services 956 for the connection network system 900, such as network services provided by a security application 914, a server application 916, a messaging application 918, a content delivery application 920, a ranking model 922, and/or a recommendation model 924. The server device 902 has access to one or more data stores 926. The data stores 926 store information for the connection network platform 912, such as entity data 928, entity activity data 930, connection graph data 932, and content items 934.

The connection network system 900 comprises a server device 902. In particular embodiments, a server device 902 may be an electronic device including hardware, software, or embedded logic components or a combination of two or more such components and capable of carrying out the appropriate functionalities implemented or supported by a server device 902. The server device 902 may comprise a unitary server or a distributed server spanning multiple computers or multiple data centers. The server device 902 may comprise one or more physical servers or virtual servers hosting one or more networking applications. As an example and not by way of limitation, a server device 902 may comprise part of a larger server system comprising multiple server devices organized as a data center, an edge computing center, or a cloud-computing center. This disclosure contemplates any suitable server device 902. A server device 902 may be accessed by a network entity 908 at a client device 904 via the network 906. A client device 904 may enable its entity 908 to communicate with other entities 908 at the server device 902, such as via messaging applications 918.

In one embodiment, for example, the server device 902 may be implemented as a web server. The web server may be used for linking the connection network platform 912 to one or more of the client devices 904 via a network 906. The web server may include a mail server or other messaging functionality for receiving and routing messages between the connection network platform 912 and one or more client devices 904. An API-request server may allow a gaming platform, a third-party system, a messaging system, and/or an AI system to access information from the connection network platform 912 by calling one or more APIs. An action logger may be used to receive communications from a web server about a user's actions on or off the connection network platform 912. In conjunction with the action log, a third-party-content-object log may be maintained of user exposures to third-party-content objects. A notification controller may provide information regarding content objects to a client device 904. Information may be pushed to a client device 904 as notifications, or information may be pulled from a client device 904 responsive to a request received from a client device 904. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 912 or shared with other systems (e.g., a third-party system), such as, for example, by setting appropriate privacy settings. Third-party-content-object stores may be used to store content objects received from third parties, such as a third-party system. Location stores may be used for storing location information received from client device 904 associated with users. Advertisement-pricing modules may combine connections information, the current time, location information, or other suitable information to provide relevant advertisements, in the form of notifications, to a user.

The connection network system 900 comprises a connection network platform 912. In particular embodiments, the connection network platform 912 may be part of a network-addressable computing system that can host an online connection network. The connection network platform 912 may generate, store, receive, and send connection networking data, such as, for example, entity data 928 (e.g., user-profile data, concept-profile data, etc.), entity activity data 930 (e.g., user interactions with connection network platform 912), connection graph data 932 (e.g., connections between users or entities), content items 934, or other suitable data related to the online connection network. The connection network platform 912 may be accessed by the other components of the connection network system 900 either directly or via a network 906. As an example and not by way of limitation, a client device 904 may access the connection network platform 912 using the client application 910, which may be a web browser or a native application associated with the connection network platform 912 (e.g., a mobile connection network application, another suitable application, or any combination thereof) either directly or via a network 906.

The connection network platform 912 comprises a security application 914. In particular embodiments, a security application 914 may be an application or electronic device including hardware, software, or embedded logic components or a combination of two or more such components and capable of carrying out the appropriate functionalities implemented or supported by the security application 914. The security application 914 is a network security system that encompasses a suite of technologies, policies, and practices designed to protect the integrity, confidentiality, and availability of data within the connection network platform 912 from unauthorized access, attacks, and other security threats. The security application 914 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 914 implements security practices to ensure a robust defense against a wide array of cyber threats, safeguarding organizational assets and maintaining trust with stakeholders.

The connection network platform 912 comprises a server application 916. In particular embodiments, the server application 916 may be a web server to serve content information, such as content items 934, to the client application 910 of the client device 904. The server device 902 may accept an HTTP request and communicate to a client device 904 one or more HTML files responsive to the HTTP request. The server device 902 may send HTML files representing a webpage with content information for presentation via an electronic display of the client device 904 to the entity 908.

In particular embodiments, the server application 916 may be an application operable to provide various computing functionalities, services, and/or resources, and to send data to and receive data from the other entities of the network 906, such as the client device 904, the connection network platform 912, a third-party server, and other electronic devices within the connection network system 900. For example, the server application 916 may be an e-commerce application, a content application, an advertisement application, a web interface, a messaging application, a video application, a webpage, and so forth.

In particular embodiments, the server application 916 may be an application for managing various applications and services provided by the online connection network hosted on the connection network platform 912. In particular embodiments, the server application 916 may include hardware, software, or embedded logic components or a combination of two or more such components for carrying out the appropriate functionalities implemented or supported by connection network platform 912. Although the server device 902 is shown with a single server application 916, it should be noted that this is not by any way limiting and this disclosure contemplates any number of server applications 916.

The connection network platform 912 comprises a messaging application 918. The messaging application 918 is software that enables users to send and receive messages, including text, images, videos, and other multimedia content, over a network 906, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 912 comprises a content delivery application 920. The content delivery application 920 is a software tool that allows users to efficiently deliver content items to other users of the connection network platform 912 of the connection network system 900, such as content items 934 stored by one or more data stores 926 or third-party content servers. An example for the content delivery application 920 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 920 allows advertisers to create, manage, and analyze their ad campaigns on the platform in accordance with a larger programmatic advertising strategy. It allows for precise targeting based on entity data 928 and/or entity activity data 930, making it especially useful for business-to-business (B2B) or business-to-consumer (B2C) marketing campaigns. The content delivery application 920 delivers content items 934, such as a series of one or more advertisements, to an audience of entities 908 of the connection network platform 912 of the connection network system 900. The content delivery application 920 assist advertisers in delivering content and ads to a professional audience by leveraging user profiles, job titles, industries, and other entity data 928 and entity activity data 930 collected by the connection network platform 912.

The connection network platform 912 comprises various machine learning (ML) models, such as a ranking model 922. A ranking model 922 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 912 to surface the most relevant results or recommendations to users.

The connection network platform 912 comprises various ML models, such as a recommendation model 924. A recommendation model 924 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 902 comprises, or has access to, one or more data stores 926. In particular embodiments, the connections networking system 902 may include a data store 926. The data store 926 may be used to store various types of information for the server device 902 and/or the connection network platform 912. In particular embodiments, the information stored in the data store 926 may be organized according to specific data structures. In particular embodiments, the data store 926 may be a relational, columnar, correlation, or other suitable database. Although this disclosure describes or illustrates particular types of databases, this disclosure contemplates any suitable types of databases. Particular embodiments may provide interfaces that enable a client device 904 or a connection network system 900 to manage, retrieve, modify, add, or delete, the information stored in the data store 926.

In one embodiment, for example, the data store 926 stores entity data 928 for the connection network platform 912. In particular embodiments, the connection network platform 912 may include entity data 928 for various entities of the connection network platform 912. Non-limiting examples of entities may include users, individuals, members, businesses, companies, organizations, software agents, hardware agents, and so forth. For example, the entity data 928 may comprise one or more user profiles associated with users of the connection network platform 912. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 926 stores entity activity data 930 for the connection network platform 912. The entity activity data 930 represents various activities recorded for an entity 908 by the connection network platform 912. In particular embodiments, the connection network platform 912 may provide entities (e.g., users) with the ability to take actions on various types of items or objects supported (or accessible) by connection network platform 912. As an example and not by way of limitation, the items and objects may include groups or connections networks to which users of the connection network platform 912 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 912 or by an external system of a third-party system, which is separate from the server device 902 and coupled to the server device 902 via a network 906.

In one embodiment, for example, the data store 926 stores connection graph data 932 for the connection network platform 912. The connection network platform 912 may store connection graph data 932 for one or more users (e.g., members with subscription accounts) of the connection network platform 912. In one embodiment, for example, connection graph data 932 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 912 may provide users of the online connection network system 900 the ability to communicate and interact with other users. In particular embodiments, users may join the online connection network platform 912 via the connection network system 900 and then add connections (e.g., relationships) to a number of other users of the connection network platform 912 to whom they want to be connected. Herein, the term “connection” may refer to any other user of the connection network platform 912 or the connection network system 900 with whom a user has formed a friendship, association, or relationship via the connection network platform 912.

In one embodiment, for example, the data store 926 stores content items 934 for the connection network platform 912. The content items 934 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 912 also includes user-generated content (UGC) objects, which may enhance a user's interactions with the connection network platform 912. User-generated content may include anything a user can add, upload, send, message, or “post” to the connection network platform 912. As an example and not by way of limitation, a user communicates posts to the connection network platform 912 from a client device 904. Posts may include data such as status updates or other textual data, articles, job openings, company information, awards, location information, photos, videos, links, music or other similar data or media. Content may also be added to the connection network platform 912 by a third-party through a “communication channel,” such as a newsfeed or content stream.

The connection network system 900 comprises a client device 904. In particular embodiments, a client device 904 may be an electronic device including hardware, software, or embedded logic components or a combination of two or more such components and capable of carrying out the appropriate functionalities implemented or supported by a client device 904. As an example and not by way of limitation, a client device 904 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 904. A client device 904 may enable a network user at a client device 904 to access a network 906. A client device 904 may enable its entity 908 to communicate with other entities 908 at other client devices 904, such as via messaging application 918.

The connection network system 900 comprises a client application 910. In particular embodiments, a client device 904 may include a client application 910, which may be a web browser, and may have one or more add-ons, plug-ins, or other extensions. An entity 908 at a client device 904 may enter a Uniform Resource Locator (URL) or other address directing a web browser to a particular server device 902 such as a server or server data center for a connection network platform 912, and the web browser may generate a Hyper Text Transfer Protocol (HTTP) request and communicate the HTTP request to the server device 902. The server device 902 may accept the HTTP request and communicate to a client device 904 one or more Hyper Text Markup Language (HTML) files responsive to the HTTP request. The client device 904 may render a web interface (e.g. a webpage) based on the HTML files from the server for presentation via an electronic display of the client device 904 to the entity 908. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 910 may be an application operable to provide various computing functionalities, services, and/or resources, and to send data to and receive data from the other entities of the network 906, such as the connection network platform 912. For example, the client application 910 may be a client connection network application tightly integrated with the connection network platform 912, a messaging application 918 for messaging with entities 908 of a messaging network or system, a web browser application, an internet searching application, and so forth.

In particular embodiments, the client application 910 may be storable in a memory and executable by a processor circuitry of the client device 904 to render user interfaces, receive user input, send data to and receive data from the connection network platform 912. The client application 910 may generate and present user interfaces to a user via an electronic display of the client device 904. For example, the client application 910 may generate and present a GUI 936 based at least in part on information received from the server device 902, the connection network platform 912, and/or another device or system (e.g., a third party server) via the network 906.

In some embodiments, the connection network platform 912 and/or the client application 910 and/or an operating system of the client device 904 may generate a GUI 936 on an electronic display of the client device 904. The client application 910 may receive one or more content items 934 from the data store 926 of the connection network platform 912 from the content delivery application 920. The client application 910 may display the content items 934 as content items 940 on a content feed 938 of the GUI 936. The content items 940 may include a feedback element 952 that when selected or activated by the entity 908, causes the GUI 936 to generate a signal such as a message for delivery to the content delivery application 920 of the connection network platform 912. The signal or message may comprise a feedback signal to the content delivery application 920 for use by the content delivery application 920 to select a new content item from the data store 926 for delivery to the client device 904. For example, the content delivery application 920 may use the feedback signal as part of an ML model to select content items 934 for a marketing campaign managed by the content delivery application 920, as described in more detail with reference to FIG. 1.

The connection network system 900 comprises a network 906. This disclosure contemplates any suitable network 906. As an example and not by way of limitation, one or more portions of a network 906 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 906 may comprise multiple networks 906.

In operation, an entity 908 interacts with a client application 910 of the client device 904 to access applications and services provided by a connection network platform 912 of the server device 902 via one or more links 954 of the network 906. The links 954 may connect each client device 904 to the connection network platform 912 via the network 906. This disclosure contemplates any suitable link 954. In particular embodiments, one or more links 954 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 954 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 954, or a combination of two or more such links 954. Links 954 need not necessarily operate at the same throughout. One or more first links 954 may differ in one or more respects from one or more second links 954.

FIG. 10 illustrates an embodiment of a computing architecture 1000. Computing architecture 1000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1000 has a single processor with one core or more than one processor. Note that the term “processor” refers to a processor with a single core or a processor package with multiple processor cores. In at least one embodiment, the computing computing architecture 1000 is representative of the components of the system 600. More generally, the computing computing architecture 1000 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1000. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 10, computing architecture 1000 comprises a system-on-chip (SoC) 1002 for mounting platform components. System-on-chip (SoC) 1002 is a point-to-point (P2P) interconnect platform that includes a first processor 1004 and a second processor 1006 coupled via a point-to-point interconnect 1070 such as an Ultra Path Interconnect (UPI). In other embodiments, the computing architecture 1000 is another bus architecture, such as a multi-drop bus. Furthermore, each of processor 1004 and processor 1006 are processor packages with multiple processor cores including core(s) 1008 and core(s) 1010, respectively. While the computing architecture 1000 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1004 and chipset 1032. Some platforms include additional components and some platforms include sockets to mount the processors and/or the chipset. Furthermore, some platforms do not have sockets (e.g. SoC, or the like). Although depicted as a SoC 1002, one or more of the components of the SoC 1002 are included in a single die package, a multi-chip module (MCM), a multi-die package, a chiplet, a bridge, and/or an interposer. Therefore, embodiments are not limited to a SoC.

The processor 1004 and processor 1006 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1004 and/or processor 1006. Additionally, the processor 1004 need not be identical to processor 1006.

Processor 1004 includes an integrated memory controller (IMC) 1020 and point-to-point (P2P) interface 1024 and P2P interface 1028. Similarly, the processor 1006 includes an IMC 1022 as well as P2P interface 1026 and P2P interface 1030. IMC 1020 and IMC 1022 couple the processor 1004 and processor 1006, respectively, to respective memories (e.g., memory 1016 and memory 1018). Memory 1016 and memory 1018 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1016 and the memory 1018 locally attach to the respective processors (i.e., processor 1004 and processor 1006). In other embodiments, the main memory couple with the processors via a bus and shared memory hub. Processor 1004 includes registers 1012 and processor 1006 includes registers 1014.

Computing architecture 1000 includes chipset 1032 coupled to processor 1004 and processor 1006. Furthermore, chipset 1032 are coupled to storage device 1050, for example, via an interface (I/F) 1038. The I/F 1038 may be, for example, a Peripheral Component Interconnect-enhanced (PCIe) interface, a Compute Express Link® (CXL) interface, or a Universal Chiplet Interconnect Express (UCIe) interface. Storage device 1050 stores instructions executable by circuitry of computing architecture 1000 (e.g., processor 1004, processor 1006, GPU 1048, accelerator 1054, vision processing unit 1056, or the like). For example, storage device 1050 can store instructions for the client device 602, the client device 606, the inferencing device 604, the training device 1102, or the like.

Processor 1004 couples to the chipset 1032 via P2P interface 1028 and P2P 1034 while processor 1006 couples to the chipset 1032 via P2P interface 1030 and P2P 1036. Direct media interface (DMI) 1076 and DMI 1078 couple the P2P interface 1028 and the P2P 1034 and the P2P interface 1030 and P2P 1036, respectively. DMI 1076 and DMI 1078 is a high-speed interconnect that facilitates, e.g., eight Giga Transfers per second (GT/s) such as DMI 3.0. In other embodiments, the processor 1004 and processor 1006 interconnect via a bus.

The chipset 1032 comprises a controller hub such as a platform controller hub (PCH). The chipset 1032 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1032 comprises more than one controller hub such as a chipset with a memory controller hub, a graphics controller hub, and an input/output (I/O) controller hub.

In the depicted example, chipset 1032 couples with a trusted platform module (TPM) 1044 and UEFI, BIOS, FLASH circuitry 1046 via I/F 1042. The TPM 1044 is a dedicated microcontroller designed to secure hardware by integrating cryptographic keys into devices. The UEFI, BIOS, FLASH circuitry 1046 may provide pre-boot code. The I/F 1042 may also be coupled to a network interface circuit (NIC) 1080 for connections off-chip.

Furthermore, chipset 1032 includes the I/F 1038 to couple chipset 1032 with a high-performance graphics engine, such as, graphics processing circuitry or a graphics processing unit (GPU) 1048. In other embodiments, the computing architecture 1000 includes a flexible display interface (FDI) (not shown) between the processor 1004 and/or the processor 1006 and the chipset 1032. The FDI interconnects a graphics processor core in one or more of processor 1004 and/or processor 1006 with the chipset 1032.

The computing architecture 1000 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1054 and/or vision processing unit 1056 are coupled to chipset 1032 via I/F 1038. The accelerator 1054 is representative of any type of accelerator device (e.g., a data streaming accelerator, cryptographic accelerator, cryptographic co-processor, an offload engine, etc.). One example of an accelerator 1054 is the Intel® Data Streaming Accelerator (DSA). The accelerator 1054 is a device including circuitry to accelerate copy operations, data encryption, hash value computation, data comparison operations (including comparison of data in memory 1016 and/or memory 1018), and/or data compression. Examples for the accelerator 1054 include a USB device, PCI device, PCIe device, CXL device, UCIe device, and/or an SPI device. The accelerator 1054 also includes circuitry arranged to execute machine learning (ML) related operations (e.g., training, inference, etc.) for ML models. Generally, the accelerator 1054 is specially designed to perform computationally intensive operations, such as hash value computations, comparison operations, cryptographic operations, and/or compression operations, in a manner that is more efficient than when performed by the processor 1004 or processor 1006. Because the load of the computing architecture 1000 includes hash value computations, comparison operations, cryptographic operations, and/or compression operations, the accelerator 1054 greatly increases performance of the computing architecture 1000 for these operations.

The accelerator 1054 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1054. For example, the accelerator 1054 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1054 via a non-posted write (e.g., a deferred memory write (DMWr)). One example of an instruction that atomically submits a work descriptor to the shared work queue of the accelerator 1054 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1054. The dedicated work queue may accept job submissions via commands such as the movdir64b instruction.

Various I/O devices 1060 and display 1052 couple to the bus 1072, along with a bus bridge 1058 which couples the bus 1072 to a second bus 1074 and an I/F 1040 that connects the bus 1072 with the chipset 1032. In one embodiment, the second bus 1074 is a low pin count (LPC) bus. Various input/output (I/O) devices couple to the second bus 1074 including, for example, a keyboard 1062, a mouse 1064 and communication devices 1066.

Furthermore, an audio I/O 1068 couples to second bus 1074. Many of the I/O devices 1060 and communication devices 1066 reside on the system-on-chip (SoC) 1002 while the keyboard 1062 and the mouse 1064 are add-on peripherals. In other embodiments, some or all the I/O devices 1060 and communication devices 1066 are add-on peripherals and do not reside on the system-on-chip (SoC) 1002.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

1. A method, comprising:
receiving an input vector comprising bid request data associated with a bid request;
generating a bid upper boundary value for a prediction interval based on the input vector using a first machine learning (ML) model, the first ML model trained on a first set of training datapoints, wherein each first training datapoint comprises an accepted bid from a first set of auctions;
generating a bid lower boundary value for the prediction interval based on the input vector using a second ML model, the second ML model trained on a second set of training datapoints, wherein each second training datapoint comprises a rejected bid from a second set of auctions;
selecting a bid value from a range of candidate bid values of the prediction interval;
sending bid response data comprising the selected bid value in response to the bid request;
receiving a notification indicating the selected bid value comprises an accepted bid; and
sending content item data for a digital content item for presentation in a content item slot of a digital medium as the digital medium loads in a web browser.

2. (canceled)

3. The method of claim 1, comprising:
generating an exploration parameter that controls a level of exploration within the prediction interval based on real-time auction data and a performance metric; and
selecting a bid value from the range of candidate bid values based on the exploration parameter.

4. The method of claim 1, comprising:
generating a score for each candidate bid value in the range of candidate bid values within the prediction interval, the score representing a probability of the candidate bid value winning the bid to present a digital content item in a content item slot of a digital medium; and
selecting the bid value from the range of candidate bid values based on the score.

5. The method of claim 1, wherein the selected bid value comprises a predicted minimum accepted bid price for a tier of bid values within a set of tiers ordered by value.

6. The method of claim 1, comprising training the first ML model on a first set of training datapoints, wherein a first training datapoint comprises an accepted bid from the first set of auctions.

7. The method of claim 1, comprising training the second ML model on a second set of training datapoints, wherein a second training datapoint comprises a rejected bid from the second set of auctions.

8. The method of claim 1, comprising training the first ML model or the second ML model on a first set of training datapoints and a second set of training datapoints, wherein a first training datapoint comprises an accepted bid from the first set of auctions and a second training datapoint comprises a rejected bid from the second set of auctions.

9. The method of claim 1, comprising training the first ML model, the second ML model, or a combination of the first ML model and the second ML model, using a surrogate loss function, the surrogate loss function comprising a negative log-likelihood (NLL) loss function.

10. The method of claim 9, wherein the surrogate loss function further comprises a regularization on a predicted variance and an asymmetric penalization based on a relationship between a predicted mean and a set of true values.

11. The method of claim 10, wherein the NLL loss function computes a likelihood of a true value from the set of true values under a normal distribution parameterized by the predicted mean and the predicted variance.

12. The method of claim 11, wherein the surrogate loss function applies a regularization term to the predicted variance controlled by a regularization strength value.

13. The method of claim 12, wherein the surrogate loss function adds a penalty value to the predicted variance when the predicted variance exceeds a defined threshold value in relation to the predicted mean.

14. The method of claim 13, wherein the surrogate loss function applies a first penalty value when the predicted mean is greater than a true value from the set of true values or a second penalty value when the predicted mean is less than the true value, and the first penalty value is less than the second penalty value.

15. A computing apparatus comprising:
circuitry; and
a memory storing instructions that, when executed by the circuitry, causes the circuitry to:
receive an input vector comprising bid request data associated with a bid request;
generate a bid upper boundary value for a prediction interval based on the input vector using a first machine learning (ML) model, the first ML model trained on a first set of training datapoints, wherein each first training datapoint comprises an accepted bid from a first set of auctions;
generate a bid lower boundary value for the prediction interval based on the input vector using a second ML model, the second ML model trained on a second set of training datapoints, wherein each second training datapoint comprises a rejected bid from a second set of auctions;
select a bid value from a range of candidate bid values of the prediction interval;
send bid response data comprising the selected bid value in response to the bid request;
receive a notification indicating the selected bid value comprises an accepted bid; and
send content item data for a digital content item for presentation in a content item slot of a digital medium as the digital medium loads in a web browser.

16. The computing apparatus of claim 15, the circuitry to train the first ML model, the second ML model, or a combination of the first ML model and the second ML model, using a surrogate loss function, the surrogate loss function comprising a negative log-likelihood (NLL) loss function.

17. The computing apparatus of claim 16, wherein the surrogate loss function further comprises a regularization on a predicted variance and an asymmetric penalization based on a relationship between a predicted mean and a set of true values.

18. The computing apparatus of claim 15, the circuitry to:
generate an exploration parameter that controls a level of exploration within the prediction interval based on real-time auction data and a performance metric; and
select a bid value from the range of candidate bid values based on the exploration parameter.

19. A non-transitory computer-readable storage medium, the computer-readable storage medium including instructions that when executed by a computer, cause the computer to:
receive an input vector comprising bid request data associated with a bid request;
generate a bid upper boundary value for a prediction interval based on the input vector using a first machine learning (ML) model, the first ML model trained on a first set of training datapoints, wherein each first training datapoint comprises an accepted bid from a first set of auctions;
generate a bid lower boundary value for the prediction interval based on the input vector using a second ML model, the second ML model trained on a second set of training datapoints, wherein each second training datapoint comprises a rejected bid from a second set of auctions;
select a bid value from a range of candidate bid values of the prediction interval;
send bid response data comprising the selected bid value in response to the bid request;
receive a notification indicating the selected bid value comprises an accepted bid; and
send content item data for a digital content item for presentation in a content item slot of a digital medium as the digital medium loads in a web browser.

20. The computer-readable storage medium of claim 19, comprising: generate an exploration parameter that controls a level of exploration within the prediction interval based on real-time auction data and a performance metric; and select a bid value from the range of candidate bid values based on the exploration parameter.
